(19) United States
(12) Patent Application Publication
(10) Pub. No.: US 2025/0133406 A1
(43) Pub. Date: Apr. 24, 2025

(54) REMOTE PAIRING INITIATION FOR AUDIO DEVICES

(71) Applicant: Sonos, Inc., Goleta, CA (US)

(72) Inventors: Brenda Stefani, Andover, MA (US); Michelle Diane Sintov, San Francisco, CA (US); Bruce Weathered von Kugelgen, Oakland, CA (US); Gary Anthony Matulis, Santa Barbara, CA (US); Ken Hu, Boston, MA (US); Meng Wang, Woburn, MA (US); Michael Agerbak, Cambridge, MA (US)

(21) Appl. No.: 18/919,027

(22) Filed: Oct. 17, 2024

Related U.S. Application Data
(60) Provisional application No. 63/591,601, filed on Oct. 19, 2023.

(51) Int. Cl. H04W 12/50; G06F 3/16; H04M 1/72412; H04W 12/06; H04W 76/14

(52) U.S. Cl. CPC H04W 12/50; G06F 3/165; H04W 12/06; H04W 76/14; H04M 1/72412

(57) ABSTRACT

An audio playback device is provided. The audio playback device includes an audio transducer; a communication interface; a processor; and a non-transitory computer-readable medium comprising program instructions that are executable by the processor. The instructions are executable by the processor such that the audio playback device is configured to detect, from a computing device executing a controller application, a request to enter a pairing mode and a security credential associated with a user account associated with the audio playback device or the controller application; validate the security credential; based on the credential being valid, enter the pairing mode, wirelessly pair with an external device, and wirelessly detect audio content from the at least one external device and play back the audio content, or wirelessly send audio content to the at least one external device.

### CROSS-REFERENCE TO RELATED APPLICATION

This application claims priority under 35 U.S.C. § 119 (e) to co-pending U.S. Provisional Application No. 63/591,601 filed on Oct. 19, 2023, which is hereby incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when Sonos, Inc. began development of a new type of playback system. Sonos then filed one of its first patent applications in 2003, entitled “Method for Synchronizing Audio Playback between Multiple Networked Devices,” and began offering its first media playback systems for sale in 2005. The SONOS Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIGS. 1I through IL are schematic diagrams of corresponding media playback system zones.

FIG. 1M is a schematic diagram of media playback system areas.

FIG. 2A is a front isometric view of a playback device configured in accordance with aspects of the disclosed technology.

FIG. 2B is a front isometric view of the playback device of FIG. 2A without a grille.

FIG. 2C is an exploded view of the playback device of FIG. 2A.

FIG. 3A is a front view of a network microphone device configured in accordance with aspects of the disclosed technology.

FIG. 3B is a side isometric view of the network microphone device of FIG. 3A.

FIG. 3C is an exploded view of the network microphone device of FIGS. 3A and 3B.

FIG. 3D is an enlarged view of a portion of FIG. 3B.

FIG. 3E is a block diagram of the network microphone device of FIGS. 3A-3D.

FIG. 3F is a schematic diagram of an example voice input.

FIGS. 4A-4D are schematic diagrams of a control device in various stages of operation in accordance with aspects of the disclosed technology.

FIG. 5 is a front view of a control device.

FIG. 6 is a message flow diagram of a media playback system.

FIGS. 7A and 7B are block diagrams of a controller and playback devices, in accordance with at least one embodiment of the present disclosure.

FIGS. 8A and 8B are schematic diagrams of a controller user interface (UI), in accordance with at least one embodiment of the present disclosure.

FIG. 9 is a schematic diagram of a controller UI in a restricted mode, in accordance with at least one embodiment of the present disclosure.

FIG. 10A is a sequence diagram showing interactions among a computing device, cloud service, audio playback device, and external device while initiating remote audio pairing, in accordance with at least one embodiment of the present disclosure.

FIG. 10B is a sequence diagram showing interactions between a computing device and audio playback device while refreshing a status of remote audio pairing, in accordance with at least one embodiment of the present disclosure.

FIGS. 10C-10D are sequence diagrams showing interactions between a cloud service and audio playback device while validating a remote audio pairing security credential, in accordance with at least one embodiment of the present disclosure.

FIG. 11 illustrates an example process flow performed by a computing device, cloud service, audio playback device, and external device in initiating remote audio pairing, in accordance with at least one embodiment of the present disclosure.

FIG. 12 illustrates an example process flow performed by a computing device and audio playback device in refreshing a status of remote audio pairing, in accordance with at least one embodiment of the present disclosure.

FIGS. 13A-13C illustrate example process flows performed by a cloud service and audio playback device in validating a remote audio pairing security credential, in accordance with at least one embodiment of the present disclosure.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Consumers want the widest array of wireless connectivity options over which to remotely control playback devices. For instance, a user may want the ability to control a playback device over a Local Area Network (LAN) (e.g., a WI-FI network), such as via a first-party application (e.g., made by a manufacturer of the playback device) and/or a third-party application (e.g., made by a streaming media service provider), as well as via a Personal Area Network (PAN) (e.g., a BLUETOOTH network). Because joining a wireless network (and/or otherwise initiating a wireless connection) is a security-sensitive operation, wireless networks typically employ at least some security measures to limit access to the network. For instance, some networks (e.g., some WI-FI networks) may be passphrase-protected, such that a new device must possess the passphrase in order to join and/or connect to the network. Additional example security measures (e.g., employed in BLUETOOTH networks) include employment of a hardware-based control on the device (such as a physical button push, a flip of a switch, or the like) before entering a pairing mode to establish a new connection, thereby ensuring that the user has physical access to the device.

Such security measures in-place for some wireless connectivity options may, in some instances, limit usability. For example, a playback device, such as a soundbar, equipped with BLUETOOTH connectivity capability may include a pairing button that is located in a cove, or other recess, of the unit. Accordingly, when the playback device is mounted on a wall or other surface (e.g., a wall-mounted soundbar), the pairing button may be very difficult (or impossible) for a user to reach without unmounting the playback device. As a result, the user may find it impractical or impossible to pair new devices to the playback device so as to initiate audio playback after the device is mounted.

Accordingly, aspects of the present disclosure relate to techniques to securely initiate the wireless connection between a playback device and an external device without requiring physical access to the playback device. Embodiments described herein relate to remotely and securely initiating a wireless connection, such as pairing, between an audio device and a computing device and/or another external device.

In some embodiments, for example, an audio playback device is provided. The audio playback device includes at least one audio transducer; at least one communication interface; at least one processor; and at least one non-transitory computer-readable medium comprising program instructions that are executable by the at least one processor. The instructions are executable by the processor such that the audio playback device is configured to receive, from a computing device executing a controller application, a request to enter a pairing mode and a security credential associated with a user account associated with the audio playback device or the controller application; validate the security credential; based on the credential being valid, enter the pairing mode, wirelessly pair with an external device, and wirelessly receive audio content from the at least one external device and play back the audio content, or wirelessly send audio content to the at least one external device.

While some examples described herein may refer to functions performed by given actors such as “users,” “listeners,” and/or other entities, it should be understood that such references are for purposes of explanation only. The claims should not be interpreted to require action by any such example actor unless explicitly required by the language of the claims themselves.

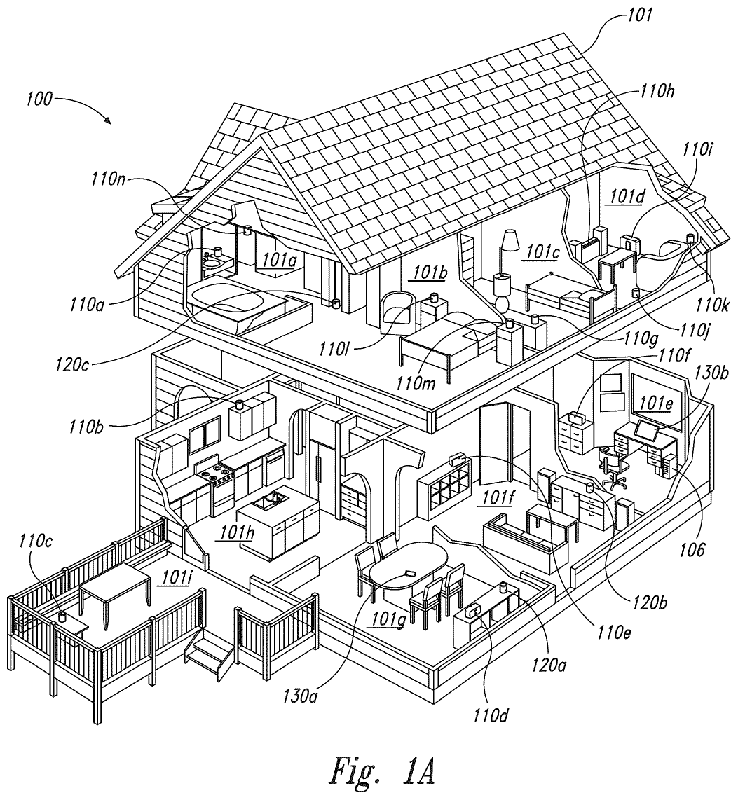

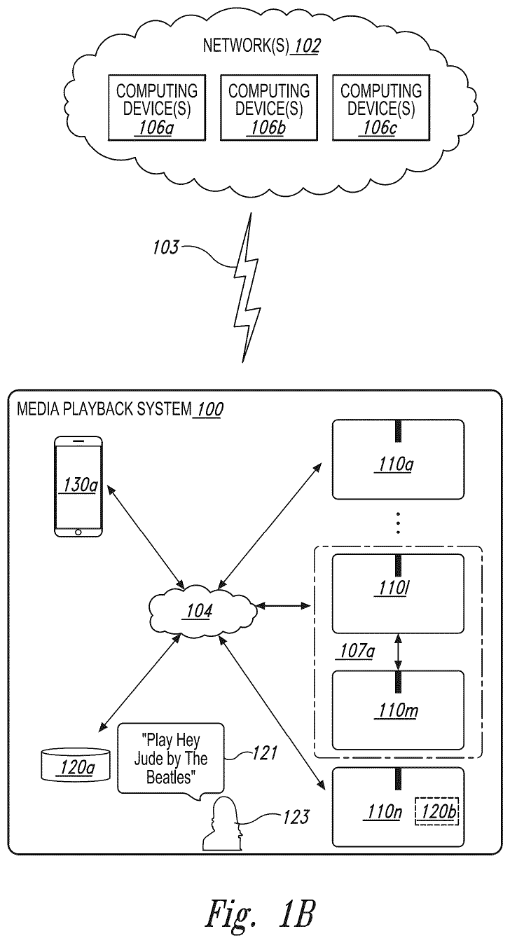

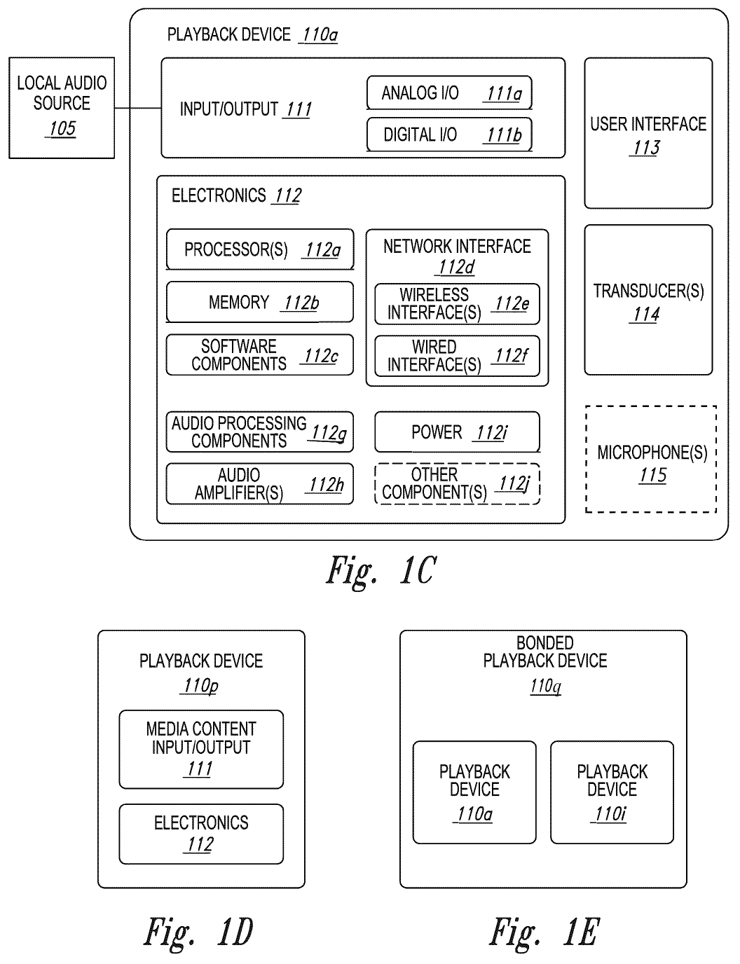

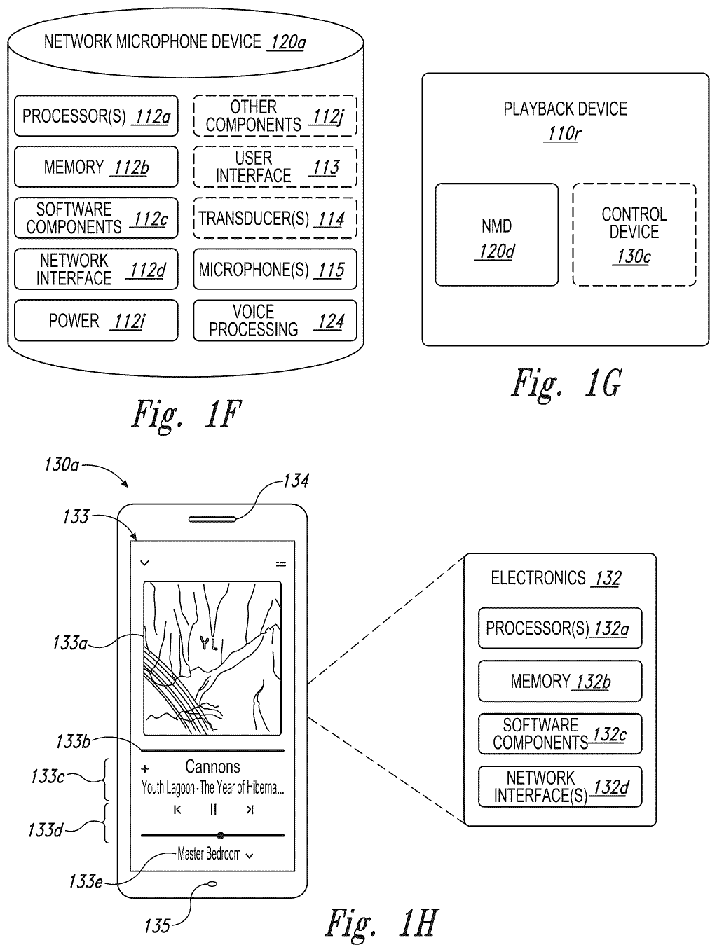

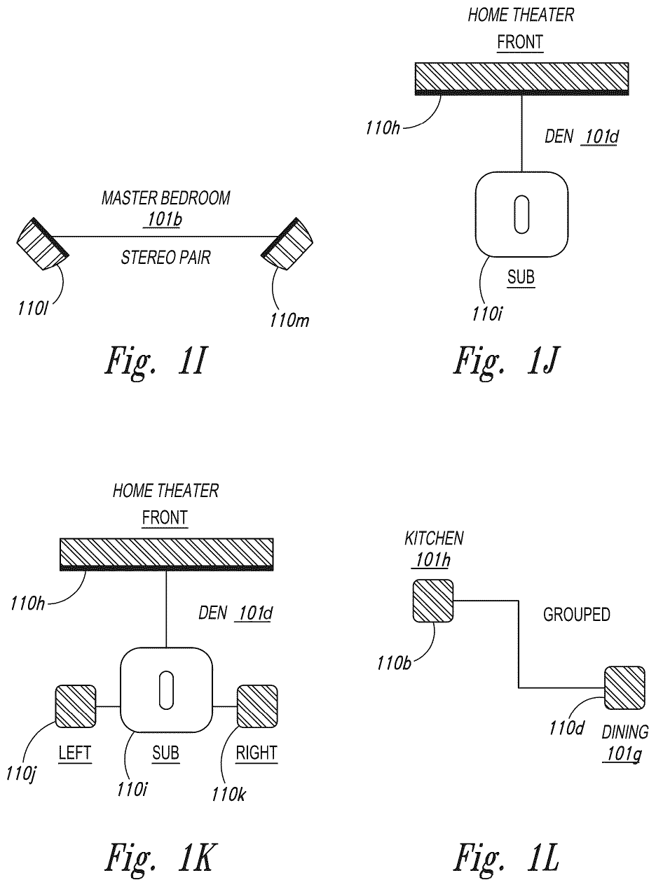

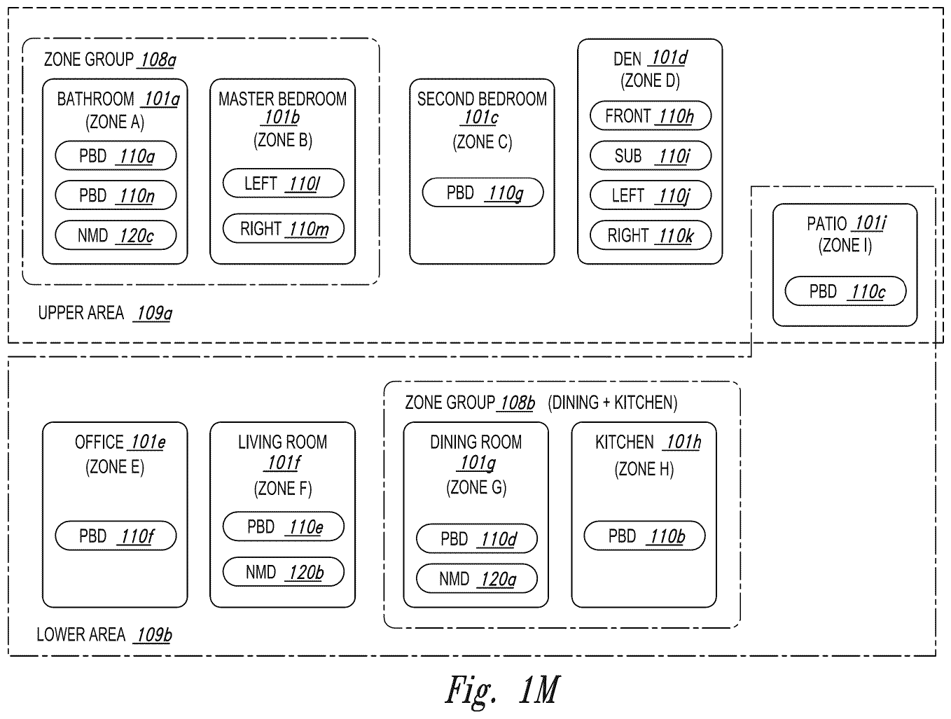

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 110a) in synchrony with a second playback device (e.g., the playback device 110b). Interactions between the playback devices 110, NMDs 120, and/or control devices 130 of the media playback system 100 configured in accordance with the various embodiments of the disclosure are described in greater detail below with respect to FIGS. 1B-6.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101c, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the second bedroom 101c, the office 101e, the living room 101f, the dining room 101g, the kitchen 101h, and the outdoor patio 101i each include one playback device 110, and the master bathroom 101a, the master bedroom 101b, and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-k can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For case of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WI-FI network, a BLUETOOTH network, a Z-WAVE network, a ZIGBEE network, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WI-FI” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WI-FI network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1I through 1M.

The media playback system 100 includes the NMDs 120a and 120b, each comprising one or more microphones configured to receive voice utterances from a user. In the illustrated embodiment of FIG. 1B, the NMD 120a is a standalone device and the NMD 120b is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS, AMAZON, GOOGLE, APPLE, MICROSOFT, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WI-FI, BLUETOOTH, or another suitable communication link. In certain embodiments, the analog I/O 111a and the digital I/O 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a BLUETOOTH connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph (such as an LP turntable), a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WI-FI, BLUETOOTH, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmit and receive media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, Sonos, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” “AMP,” “PORT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to Sonos product offerings. In some embodiments, for example, one or more playback devices 110 comprise wired or wireless headphones (e.g., over-the-ear headphones, on-ear headphones, in-car carphones, etc.). In other embodiments, one or more of the playback devices 110 comprise a docking station and/or an interface configured to interact with a docking station for personal mobile media playback devices. In certain embodiments, a playback device may be integral to another device or component such as a television, an LP turntable, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

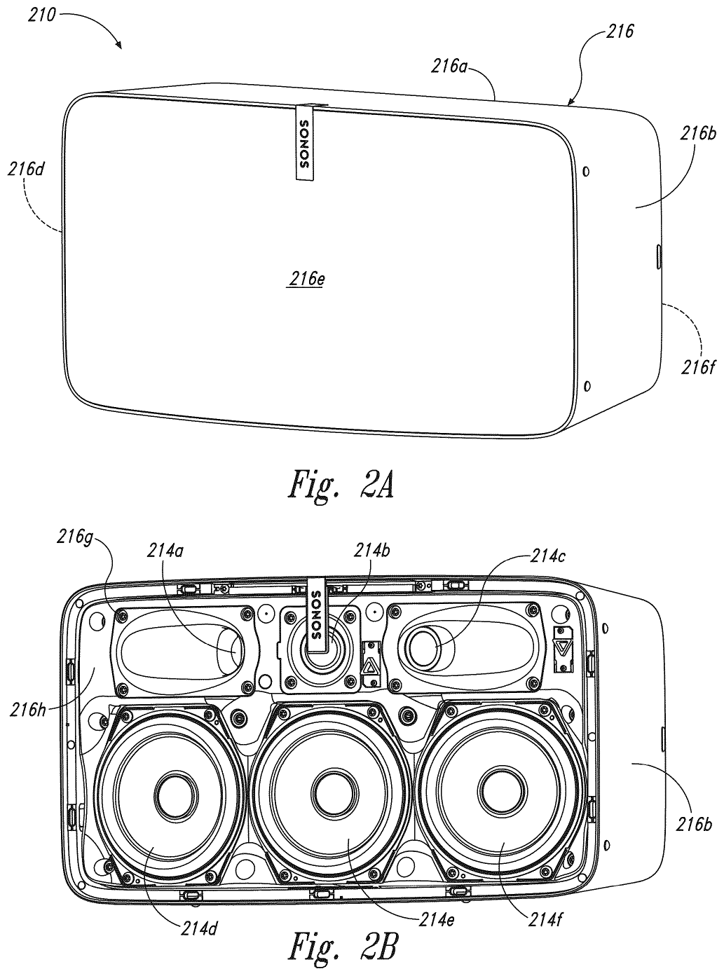

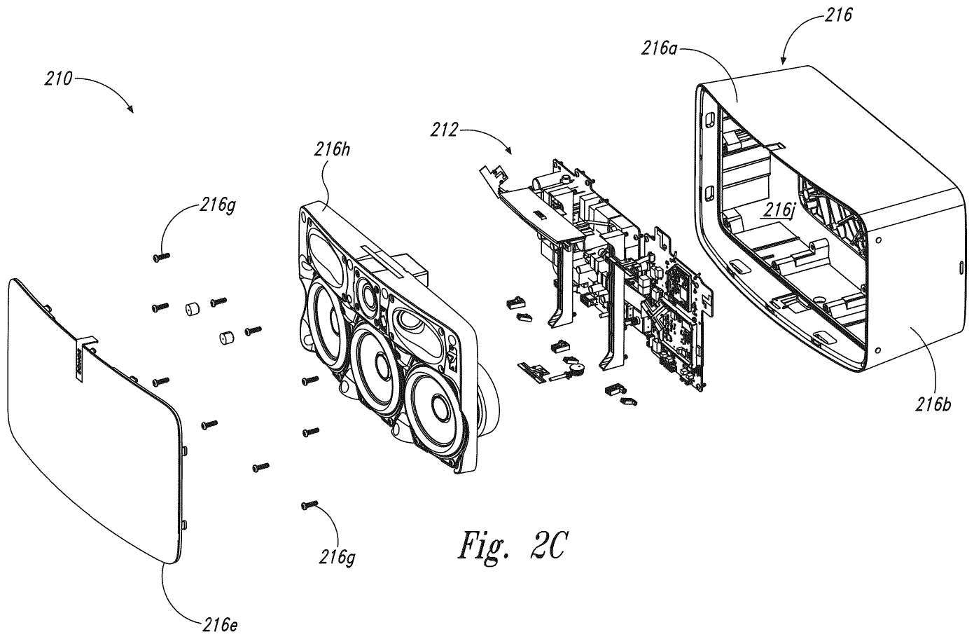

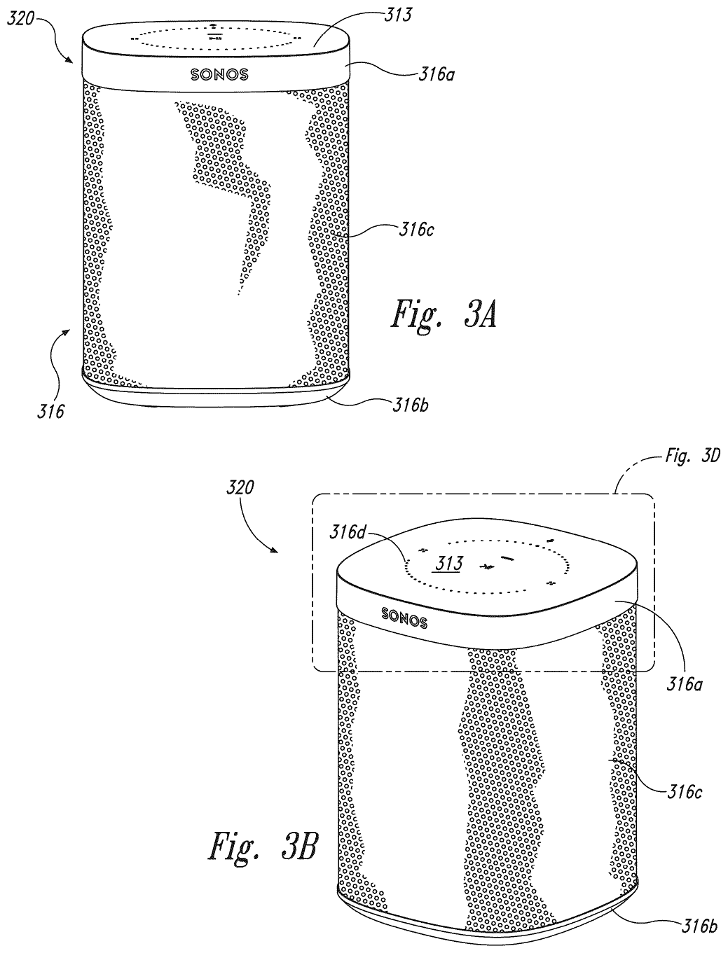

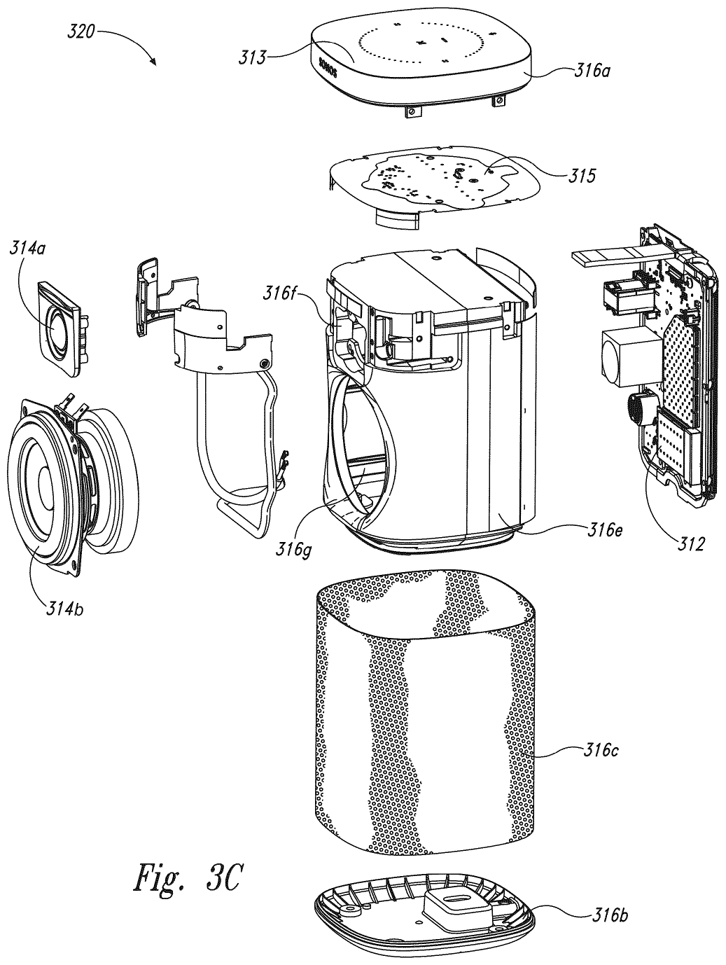

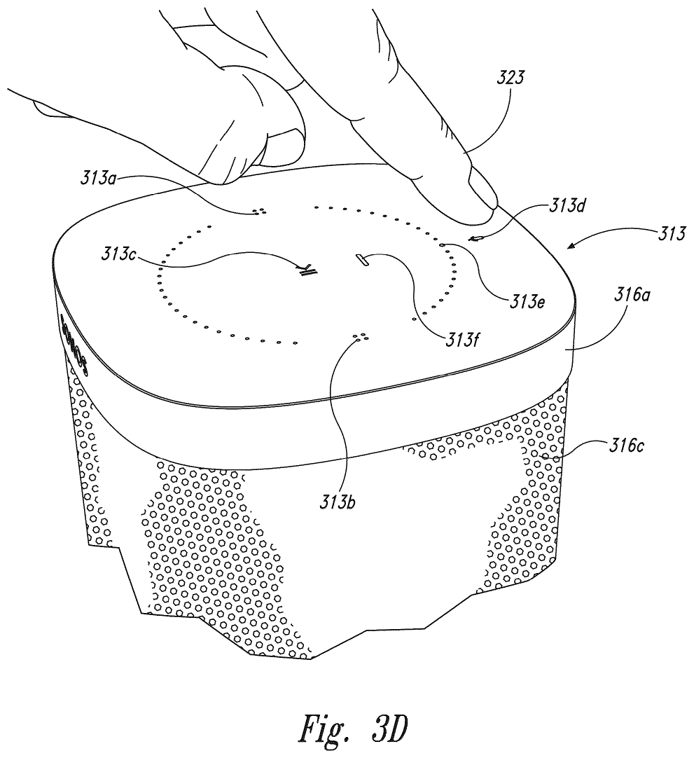

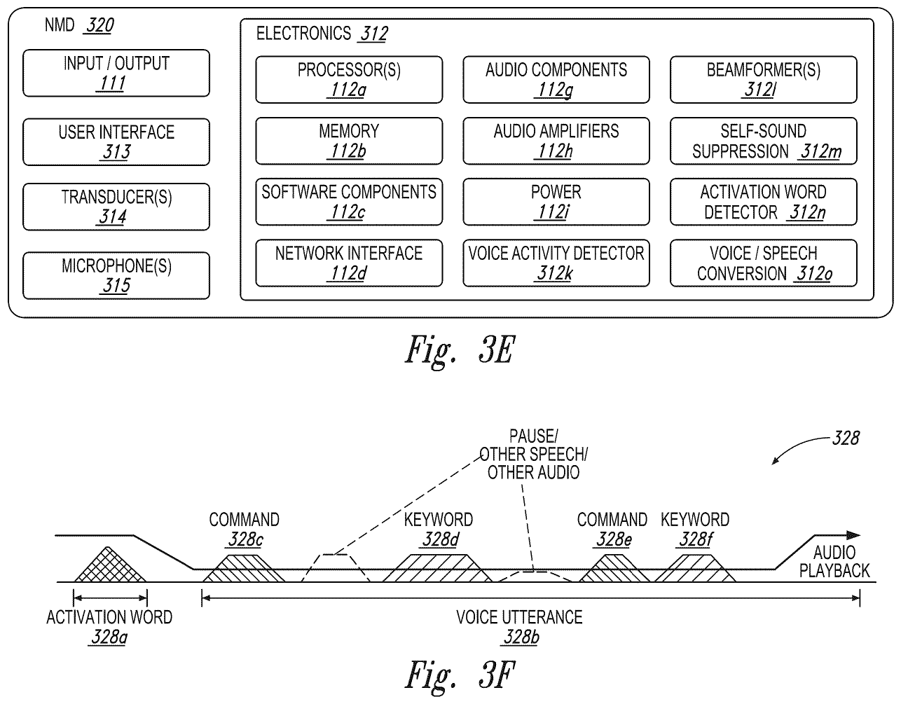

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device. Additional playback device embodiments are described in further detail below with respect to FIGS. 2A-3D.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 112h, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1C. In some aspects, for example, the NMD 120a includes the processor 112a and the memory 112b (FIG. 1C), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1C) configured to receive user input (e.g., touch input, voice input, etc.) without a separate control device. In other embodiments, however, the playback device 110r receives commands from another control device (e.g., the control device 130a of FIG. 1B). Additional NMD embodiments are described in further detail below with respect to FIGS. 3A-3F.

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON VAS, a user might speak the activation word “Alexa.” Other examples include “Ok, Google” for invoking the GOOGLE VAS and “Hey, Siri” for invoking the APPLE VAS.

After detecting the activation word, voice processing components 124 monitor the microphone data for an accompanying user request in the voice input. The user request may include, for example, a command to control a third-party device, such as a thermostat (e.g., NEST thermostat), an illumination device (e.g., a PHILIPS HUE lighting device), or a media playback device (e.g., a SONOS playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home. Additional description regarding receiving and processing voice input data can be found in further detail below with respect to FIGS. 3A-3F.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the TM an illustrated embodiment, the control device 130a comprises a smartphone (e.g., an iPhone™. Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 132a to perform those functions. The software components 132c can comprise applications and/or other executable software configured to facilitate control of the media playback system 100. The memory 132b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 130a to one or more of the playback devices 110. The network interface 132d can also transmit and/or receive configuration changes such as, for example, adding/removing one or more playback devices 110 to/from a zone, adding/removing one or more zones to/from a zone group, forming a bonded or consolidated player, separating one or more playback devices from a bonded or consolidated player, among others. Additional description of zones and groups can be found below with respect to FIGS. 1I through 1M.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™ an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

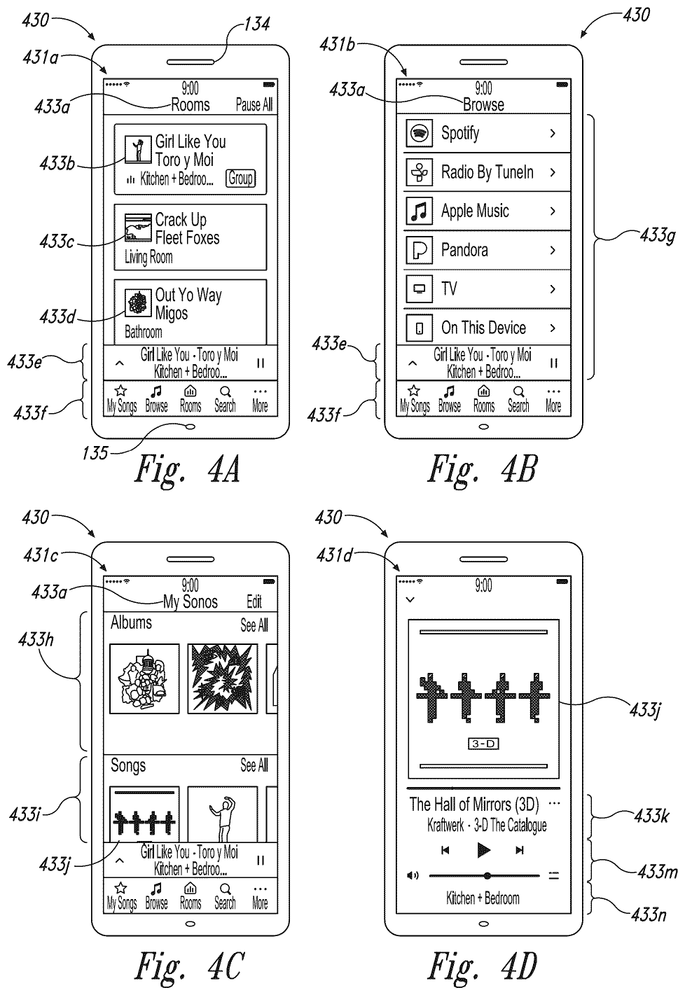

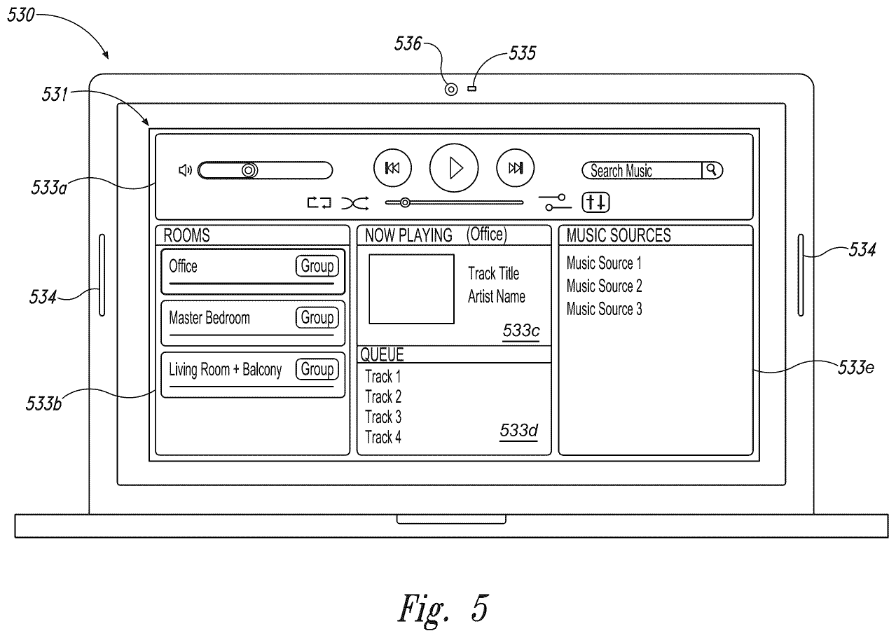

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones. Additional control device embodiments are described in further detail below with respect to FIGS. 4A-4D and 5.

c. Suitable Playback Device Configurations

FIGS. 1I through IM show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, the playback devices 110b and 110d can be merged to form a merged group or a zone group 108b. The merged playback devices 110b and 110d may not be specifically assigned different playback responsibilities. That is, the merged playback devices 110b and 110d may, aside from playing audio content in synchrony, each play audio content as they would if they were not merged.

Each zone in the media playback system 100 may be provided for control as a single user interface (UI) entity. For example, Zone A may be provided as a single entity named Master Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Left and Right devices 110j and 110k can be configured to form surround or “satellite” channels of a home theater system. The bonded playback devices 110h, 110i, 110j, and 110k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110a and 110n in the master bathroom have the single UI entity of Zone A. In one embodiment, the playback devices 110a and 110n may each output the full range of audio content each respective playback devices 110a and 110n are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in subsequently referenced U.S. Pat. No. 10,499,146.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can be assigned a name such as “Dining+Kitchen”, as shown in FIG. 1M. In some embodiments, a zone group may be given a unique name selected by a user.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variable instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “cl” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the memory may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D and I, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. Pat. No. 10,712,997 filed Aug. 21, 2017, and titled “Room Association Based on Name,” and U.S. Pat. No. 8,483,853 filed Sep. 11, 2007, and titled “Controlling and manipulating groupings in a multi-zone media system.” Each of these patents is incorporated herein by reference in its entirety. In some embodiments, the media playback system 100 may not implement Areas, in which case the system may not store variables associated with Areas.

### III. Example Systems and Devices

FIG. 2A is a front isometric view of a playback device 210 configured in accordance with aspects of the disclosed technology. FIG. 2B is a front isometric view of the playback device 210 without a grille 216e. FIG. 2C is an exploded view of the playback device 210. Referring to FIGS. 2A-2C together, the playback device 210 comprises a housing 216 that includes an upper portion 216a, a right or first side portion 216b, a lower portion, a left or second side portion 216d, the grille 216e, and a rear portion 216f. A plurality of fasteners 216g (e.g., one or more screws, rivets, clips) attaches a frame 216h to the housing 216. A cavity 216j (FIG. 2C) in the housing 216 is configured to receive the frame 216h and electronics 212. The frame 216h is configured to carry a plurality of transducers 214 (identified individually in FIG. 2B as transducers 214a-f). The electronics 212 (e.g., the electronics 112 of FIG. 1C) are configured to receive audio content from an audio source and send electrical signals corresponding to the audio content to the transducers 214 for playback.

The transducers 214 are configured to receive the electrical signals from the electronics 112, and further configured to convert the received electrical signals into audible sound during playback. For instance, the transducers 214a-c (e.g., tweeters) can be configured to output high frequency sound (e.g., sound waves having a frequency greater than about 2 kHz). The transducers 214d-f (e.g., mid-woofers, woofers, midrange speakers) can be configured output sound at frequencies lower than the transducers 214a-c (e.g., sound waves having a frequency lower than about 2 kHz). In some embodiments, the playback device 210 includes a number of transducers different than those illustrated in FIGS. 2A-2C. For example, as described in further detail below with respect to FIGS. 3A-3C, the playback device 210 can include fewer than six transducers (e.g., one, two, three). In other embodiments, however, the playback device 210 includes more than six transducers (e.g., nine, ten). Moreover, in some embodiments, all or a portion of the transducers 214 are configured to operate as a phased array to desirably adjust (e.g., narrow or widen) a radiation pattern of the transducers 214, thereby altering a user's perception of the sound emitted from the playback device 210.

In some examples, a filter is axially aligned with the transducer 214b. The filter can be configured to desirably attenuate a predetermined range of frequencies that the transducer 214b outputs to improve sound quality and a perceived sound stage output collectively by the transducers 214. In some embodiments, however, the playback device 210 omits the filter. In other embodiments, the playback device 210 includes one or more additional filters aligned with the transducers 214b and/or at least another of the transducers 214.

FIGS. 3A and 3B are front and right isometric side views, respectively, of an NMD 320 configured in accordance with embodiments of the disclosed technology. FIG. 3C is an exploded view of the NMD 320. FIG. 3D is an enlarged view of a portion of FIG. 3B including a user interface 313 of the NMD 320. Referring first to FIGS. 3A-3C, the NMD 320 includes a housing 316 comprising an upper portion 316a, a lower portion 316b and an intermediate portion 316c (e.g., a grille). A plurality of ports, holes or apertures 316d in the upper portion 316a allow sound to pass through to one or more microphones 315 (FIG. 3C) positioned within the housing 316. The one or more microphones 315 are configured to receive sound via the apertures 316d and produce electrical signals based on the received sound. In the illustrated embodiment, a frame 316c (FIG. 3C) of the housing 316 surrounds cavities 316f and 316g configured to house, respectively, a first transducer 314a (e.g., a tweeter) and a second transducer 314b (e.g., a mid-woofer, a midrange speaker, a woofer). In other embodiments, however, the NMD 320 includes a single transducer, or more than two (e.g., two, five, six) transducers. In certain embodiments, the NMD 320 omits the transducers 314a and 314b altogether.

Electronics 312 (FIG. 3C) includes components configured to drive the transducers 314a and 314b, and further configured to analyze audio data corresponding to the electrical signals produced by the one or more microphones 315. In some embodiments, for example, the electronics 312 comprises many or all of the components of the electronics 112 described above with respect to FIG. 1C. In certain embodiments, the electronics 312 includes components described above with respect to FIG. 1F such as, for example, the one or more processors 112a, the memory 112b, the software components 112c, the network interface 112d, etc. In some embodiments, the electronics 312 includes additional suitable components (e.g., proximity or other sensors).

Referring to FIG. 3D, the user interface 313 includes a plurality of control surfaces (e.g., buttons, knobs, capacitive surfaces) including a first control surface 313a (e.g., a previous control), a second control surface 313b (e.g., a next control), and a third control surface 313c (e.g., a play and/or pause control) that can be adjusted by a user 323. A fourth control surface 313d is configured to receive touch input corresponding to activation and deactivation of the one or microphones 315. A first indicator 313e (e.g., one or more light emitting diodes (LEDs) or another suitable illuminator) can be configured to illuminate only when the one or more microphones 315 are activated. A second indicator 313f (e.g., one or more LEDs) can be configured to remain solid during normal operation and to blink or otherwise change from solid to indicate a detection of voice activity. In some embodiments, the user interface 313 includes additional or fewer control surfaces and illuminators. In one embodiment, for example, the user interface 313 includes the first indicator 313e, omitting the second indicator 313f. Moreover, in certain embodiments, the NMD 320 comprises a playback device and a control device, and the user interface 313 comprises the user interface of the control device.

Referring to FIGS. 3A-3D together, the NMD 320 is configured to receive voice commands from one or more adjacent users via the one or more microphones 315. As described above with respect to FIG. 1B, the one or more microphones 315 can acquire, capture, or record sound in a vicinity (e.g., a region within 10 m or less of the NMD 320) and transmit electrical signals corresponding to the recorded sound to the electronics 312. The electronics 312 can process the electrical signals and can analyze the resulting audio data to determine a presence of one or more voice commands (e.g., one or more activation words). In some embodiments, for example, after detection of one or more suitable voice commands, the NMD 320 is configured to transmit a portion of the recorded audio data to another device and/or a remote server (e.g., one or more of the computing devices 106 of FIG. 1B) for further analysis. The remote server can analyze the audio data, determine an appropriate action based on the voice command, and transmit a message to the NMD 320 to perform the appropriate action. For instance, a user may speak “Sonos, play Michael Jackson.” The NMD 320 can, via the one or more microphones 315, record the user's voice utterance, determine the presence of a voice command, and transmit the audio data having the voice command to a remote server (e.g., one or more of the remote computing devices 106 of FIG. 1B, one or more servers of a VAS and/or another suitable service). The remote server can analyze the audio data and determine an action corresponding to the command. The remote server can then transmit a command to the NMD 320 to perform the determined action (e.g., play back audio content related to Michael Jackson). The NMD 320 can receive the command and play back the audio content related to Michael Jackson from a media content source. As described above with respect to FIG. 1B, suitable content sources can include a device or storage communicatively coupled to the NMD 320 via a LAN (e.g., the network 104 of FIG. 1B), a remote server (e.g., one or more of the remote computing devices 106 of FIG. 1B), etc. In certain embodiments, however, the NMD 320 determines and/or performs one or more actions corresponding to the one or more voice commands without intervention or involvement of an external device, computer, or server.

FIG. 3E is a functional block diagram showing additional features of the NMD 320 in accordance with aspects of the disclosure. The NMD 320 includes components configured to facilitate voice command capture including voice activity detector component(s) 312k, beam former components 312l, acoustic echo cancellation (AEC) and/or self-sound suppression components 312m, activation word detector components 312n, and voice/speech conversion components 312o (e.g., voice-to-text and text-to-voice). In the illustrated embodiment of FIG. 3E, the foregoing components 312k-312o are shown as separate components. In some embodiments, however, one or more of the components 312k-312o are subcomponents of the processors 112a.

The beamforming and self-sound suppression components 312l and 312m are configured to detect an audio signal and determine aspects of voice input represented in the detected audio signal, such as the direction, amplitude, frequency spectrum, etc. The voice activity detector activity components 312k are operably coupled with the beamforming and AEC components 312l and 312m and are configured to determine a direction and/or directions from which voice activity is likely to have occurred in the detected audio signal. Potential speech directions can be identified by monitoring metrics which distinguish speech from other sounds. Such metrics can include, for example, energy within the speech band relative to background noise and entropy within the speech band, which is measure of spectral structure. As those of ordinary skill in the art will appreciate, speech typically has a lower entropy than most common background noise. The activation word detector components 312n are configured to monitor and analyze received audio to determine if any activation words (e.g., wake words) are present in the received audio. The activation word detector components 312n may analyze the received audio using an activation word detection algorithm. If the activation word detector 312n detects an activation word, the NMD 320 may process voice input contained in the received audio. Example activation word detection algorithms accept audio as input and provide an indication of whether an activation word is present in the audio. Many first- and third-party activation word detection algorithms are known and commercially available. For instance, operators of a voice service may make their algorithm available for use in third-party devices. Alternatively, an algorithm may be trained to detect certain activation words. In some embodiments, the activation word detector 312n runs multiple activation word detection algorithms on the received audio simultaneously (or substantially simultaneously). As noted above, different voice services (e.g., AMAZON's ALEXA, APPLE's SIRI, or MICROSOFT's CORTANA) can each use a different activation word for invoking their respective voice service. To support multiple services, the activation word detector 312n may run the received audio through the activation word detection algorithm for each supported voice service in parallel.

The speech/text conversion components 312o may facilitate processing by converting speech in the voice input to text. In some embodiments, the electronics 312 can include voice recognition software that is trained to a particular user or a particular set of users associated with a household. Such voice recognition software may implement voice-processing algorithms that are tuned to specific voice profile(s). Tuning to specific voice profiles may require less computationally intensive algorithms than traditional voice activity services, which typically sample from a broad base of users and diverse requests that are not targeted to media playback systems.

FIG. 3F is a schematic diagram of an example voice input 328 captured by the NMD 320 in accordance with aspects of the disclosure. The voice input 328 can include an activation word portion 328a and a voice utterance portion 328b. In some embodiments, the activation word 328a can be a known activation word, such as “Alexa,” which is associated with AMAZON's ALEXA. In other embodiments, however, the voice input 328 may not include an activation word. In some embodiments, a network microphone device may output an audible and/or visible response upon detection of the activation word portion 328a. In addition, or alternately, an NMD may output an audible and/or visible response after processing a voice input and/or a series of voice inputs.

The voice utterance portion 328b may include, for example, one or more spoken commands (identified individually as a first command 328c and a second command 328c) and one or more spoken keywords (identified individually as a first keyword 328d and a second keyword 328f). In one example, the first command 328c can be a command to play music, such as a specific song, album, playlist, etc. In this example, the keywords may be one or words identifying one or more zones in which the music is to be played, such as the Living Room and the Dining Room shown in FIG. 1A. In some examples, the voice utterance portion 328b can include other information, such as detected pauses (e.g., periods of non-speech) between words spoken by a user, as shown in FIG. 3F. The pauses may demarcate the locations of separate commands, keywords, or other information spoke by the user within the voice utterance portion 328b.

In some embodiments, the media playback system 100 is configured to temporarily reduce the volume of audio content that it is playing while detecting the activation word portion 328a. The media playback system 100 may restore the volume after processing the voice input 328, as shown in FIG. 3F. Such a process can be referred to as ducking, examples of which are disclosed in U.S. Pat. No. 10,499,146, which is incorporated by reference herein in its entirety.

FIGS. 4A-4D are schematic diagrams of a control device 430 (e.g., the control device 130a of FIG. 1H, a smartphone, a tablet, a dedicated control device, an IoT device, and/or another suitable device) showing corresponding user interface displays in various states of operation. A first user interface display 431a (FIG. 4A) includes a display name 433a (i.e., “Rooms”). A selected group region 433b displays audio content information (e.g., artist name, track name, album art) of audio content played back in the selected group and/or zone. Group regions 433c and 433d display corresponding group and/or zone name, and audio content information audio content played back or next in a playback queue of the respective group or zone. An audio content region 433c includes information related to audio content in the selected group and/or zone (i.e., the group and/or zone indicated in the selected group region 433b). A lower display region 433f is configured to receive touch input to display one or more other user interface displays. For example, if a user selects “Browse” in the lower display region 433f, the control device 430 can be configured to output a second user interface display 431b (FIG. 4B) comprising a plurality of music services 433g (e.g., Spotify, Radio by Tunein, Apple Music, Pandora, Amazon, TV, local music, line-in) through which the user can browse and from which the user can select media content for play back via one or more playback devices (e.g., one of the playback devices 110 of FIG. 1A). Alternatively, if the user selects “My Sonos” in the lower display region 433f, the control device 430 can be configured to output a third user interface display 431c (FIG. 4C). A first media content region 433h can include graphical representations (e.g., album art) corresponding to individual albums, stations, or playlists. A second media content region 433i can include graphical representations (e.g., album art) corresponding to individual songs, tracks, or other media content. If the user selects a graphical representation 433j (FIG. 4C), the control device 430 can be configured to begin play back of audio content corresponding to the graphical representation 433j and output a fourth user interface display 431d that includes an enlarged version of the graphical representation 433j, media content information 433k (e.g., track name, artist, album), transport controls 433m (e.g., play, previous, next, pause, volume), and indication 433n of the currently selected group and/or zone name.

FIG. 5 is a schematic diagram of a control device 530 (e.g., a laptop computer, a desktop computer). The control device 530 includes transducers 534, a microphone 535, and a camera 536. A user interface 531 includes a transport control region 533a, a playback status region 533c, a playback zone region 533b, a playback queue region 533d, and a media content source region 533c. The transport control region comprises one or more controls for controlling media playback including, for example, volume, previous, play/pause, next, repeat, shuffle, track position, crossfade, equalization, etc. The audio content source region 533e includes a listing of one or more media content sources from which a user can select media items for play back and/or adding to a playback queue.

The playback zone region 533b can include representations of playback zones within the media playback system 100 (FIGS. 1A and 1B). In some embodiments, the graphical representations of playback zones may be selectable to bring up additional selectable icons to manage or configure the playback zones in the media playback system, such as a creation of bonded zones, creation of zone groups, separation of zone groups, renaming of zone groups, etc. In the illustrated embodiment, a “group” icon is provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone can be configured to play audio content in synchrony with the playback device(s) in the particular zone. Analogously, a “group” icon may be provided within a graphical representation of a zone group. In the illustrated embodiment, the “group” icon may be selectable to bring up options to deselect one or more zones in the zone group to be removed from the zone group. In some embodiments, the control device 530 includes other interactions and implementations for grouping and ungrouping zones via the user interface 531. In certain embodiments, the representations of playback zones in the playback zone region 533b can be dynamically updated as playback zone or zone group configurations are modified.

The playback status region 533c includes graphical representations of audio content that is presently being played, previously played, or scheduled to play next in the selected playback zone or zone group. The selected playback zone or zone group may be visually distinguished on the user interface, such as within the playback zone region 533b and/or the playback queue region 533d. The graphical representations may include track title, artist name, album name, album year, track length, and other relevant information that may be useful for the user to know when controlling the media playback system 100 via the user interface 531.

The playback queue region 533d includes graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device. In some embodiments, for example, a playlist can be added to a playback queue, in which information corresponding to each audio item in the playlist may be added to the playback queue. In some embodiments, audio items in a playback queue may be saved as a playlist. In certain embodiments, a playback queue may be empty, or populated but “not in use” when the playback zone or zone group is playing continuously streaming audio content, such as Internet radio that may continue to play until otherwise stopped, rather than discrete audio items that have playback durations. In some embodiments, a playback queue can include Internet radio and/or other streaming audio content items and be “in use” when the playback zone or zone group is playing those items.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped.

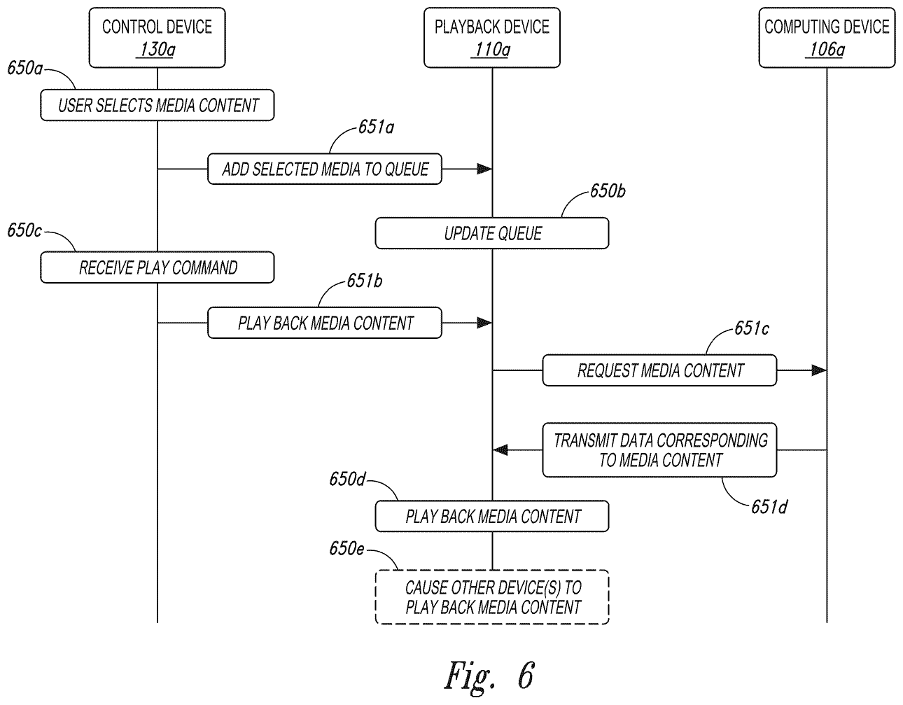

FIG. 6 is a message flow diagram illustrating data exchanges between devices of the media playback system 100 (FIGS. 1A-1M).

At step 650a, the media playback system 100 receives an indication of selected media content (e.g., one or more songs, albums, playlists, podcasts, videos, stations) via the control device 130a. The selected media content can comprise, for example, media items stored locally on one or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 130a transmits a message 651a to the playback device 110a (FIGS. 1A-1C) to add the selected media content to a playback queue on the playback device 110a.

At step 650b, the playback device 110a receives the message 651a and adds the selected media content to the playback queue for play back.

At step 650c, the control device 130a receives input corresponding to a command to play back the selected media content. In response to receiving the input corresponding to the command to play back the selected media content, the control device 130a transmits a message 651b to the playback device 110a causing the playback device 110a to play back the selected media content. In response to receiving the message 651b, the playback device 110a transmits a message 651c to the computing device 106a requesting the selected media content. The computing device 106a, in response to receiving the message 651c, transmits a message 651d comprising data (e.g., audio data, video data, a URL, a URI) corresponding to the requested media content.

At step 650d, the playback device 110a receives the message 651d with the data corresponding to the requested media content and plays back the associated media content.

At step 650c, the playback device 110a optionally causes one or more other devices to play back the selected media content. In one example, the playback device 110a is one of a bonded zone of two or more players (FIG. 1M). The playback device 110a can receive the selected media content and transmit all or a portion of the media content to other devices in the bonded zone. In another example, the playback device 110a is a coordinator of a group and is configured to transmit and receive timing information from one or more other devices in the group. The other one or more devices in the group can receive the selected media content from the computing device 106a, and begin playback of the selected media content in response to a message from the playback device 110a such that all of the devices in the group play back the selected media content in synchrony.

### IV. Remote Pairing Initiation for Audio Devices

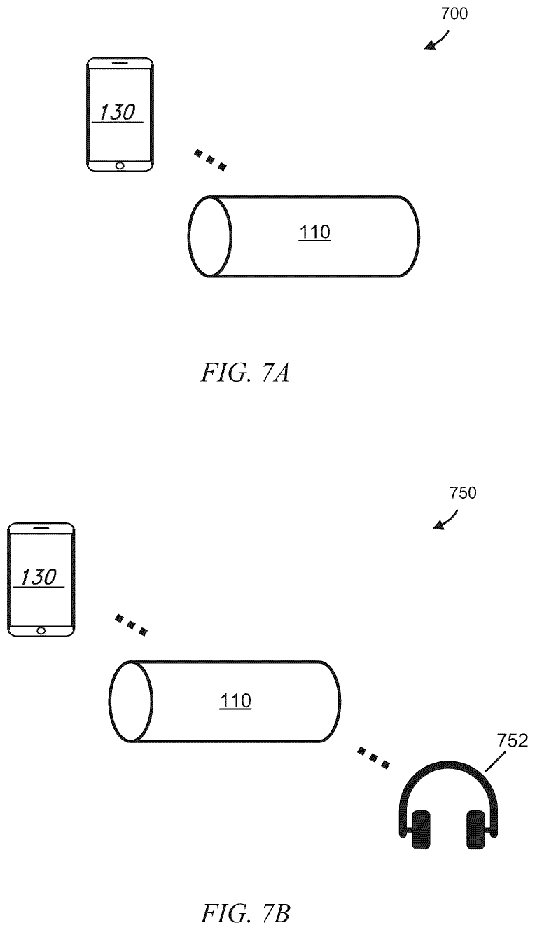

FIG. 7A is a block diagram of a system 700 including a controller 130 and a playback device 110, in accordance with at least one embodiment of the present disclosure. As disclosed herein, the elements of the system 700 can connect wirelessly in order to exchange audio content for playback. In some examples, this can include pairing wirelessly (e.g., via Bluetooth, Bluetooth Classic, or Bluetooth Low Energy (BLE)) and subsequently transmitting the audio content wirelessly.

For example, the audio playback device 110 may include a soundbar such as the SONOS ARC soundbar of SONOS, headphones, another playback device (e.g., any SONOS playback device), such as those of the examples of FIGS. 1C and 1I through 1M, or any other audio playback device.

The computing device 130 may include any mobile device, such as a mobile phone, smartphone, tablet computer, personal music player, or any other computing device or controller device, such as those of the examples of FIGS. 1H, 4A through 4D, and 5. The computing device 130 may also be referred to as a controller. In some examples, the computing device 130 can execute a controller application, such as a SONOS mobile app or another controller application.

In some examples, the elements of the system 700 can be in communication via a LAN (e.g., the network 104 of FIG. 1B) or PAN.

The elements of the system 700 can also be in communication via Bluetooth, Bluetooth Classic, or BLE. Alternatively or additionally, the elements of the system 700 can communicate with one or more cloud services and/or with each other via the Internet or another network.

In an example, the audio playback device 110 and computing device 130 can connect wirelessly in order to exchange audio content for playback. For example, the audio playback device 110 can receive audio content from the computing device 130, and can play back the received audio content.

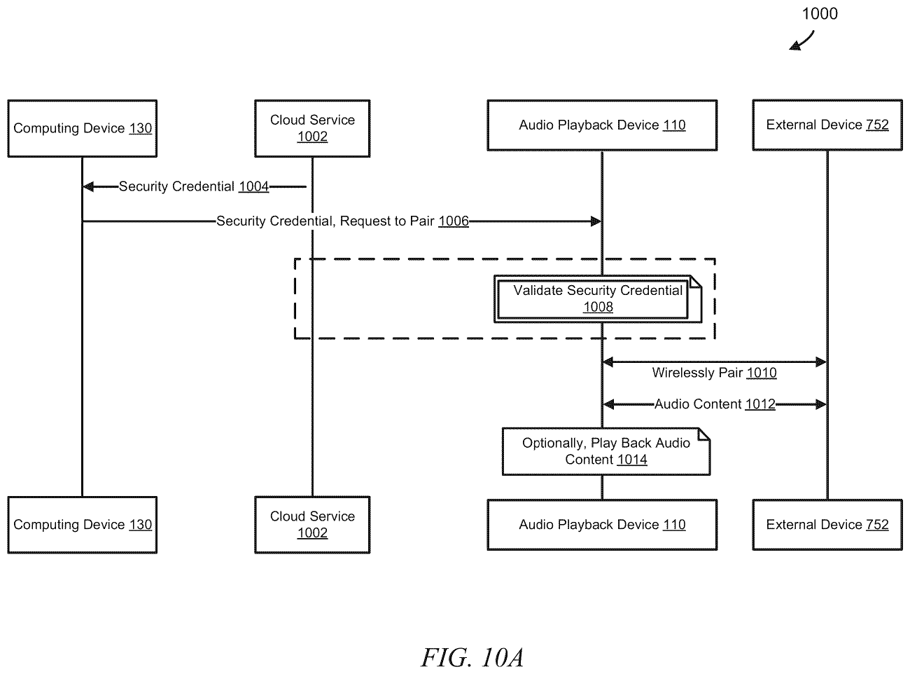

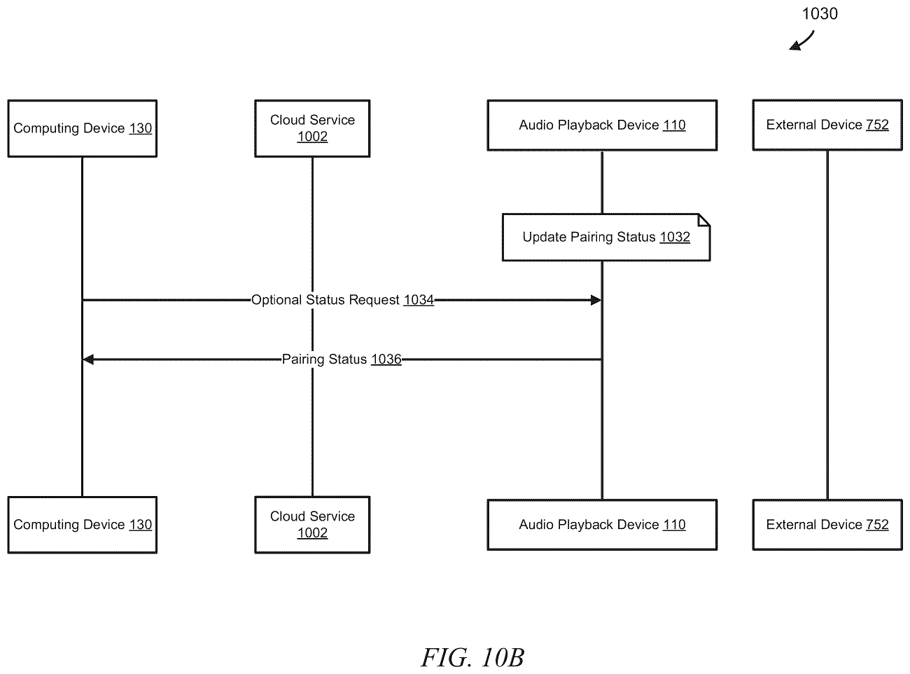

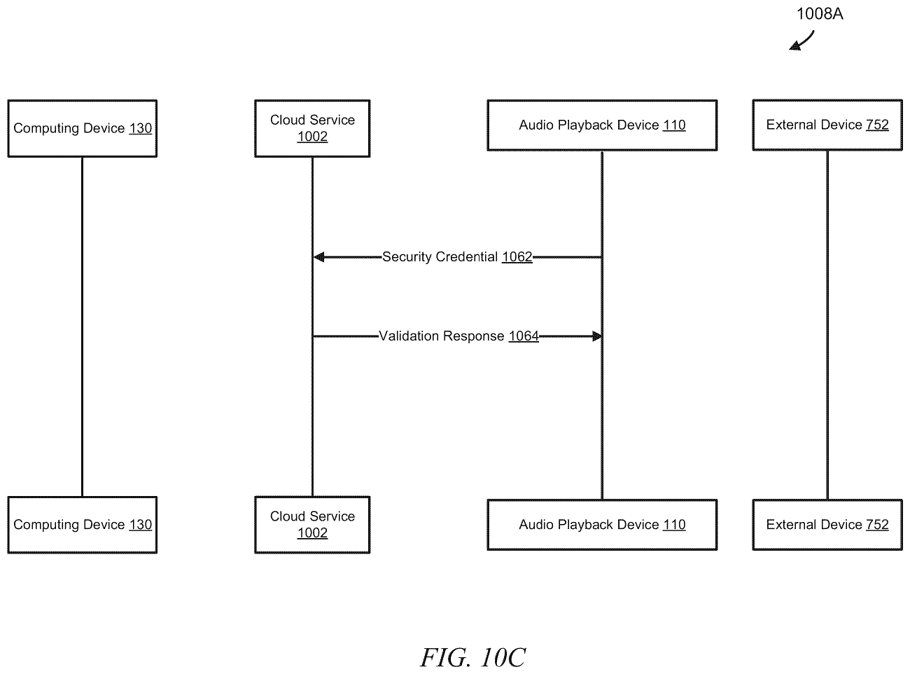

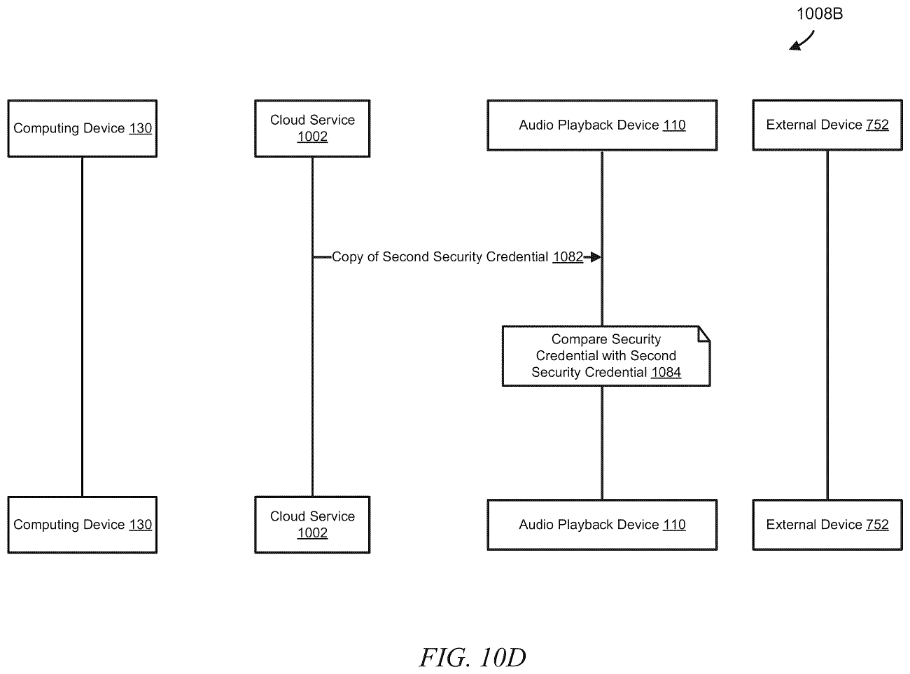

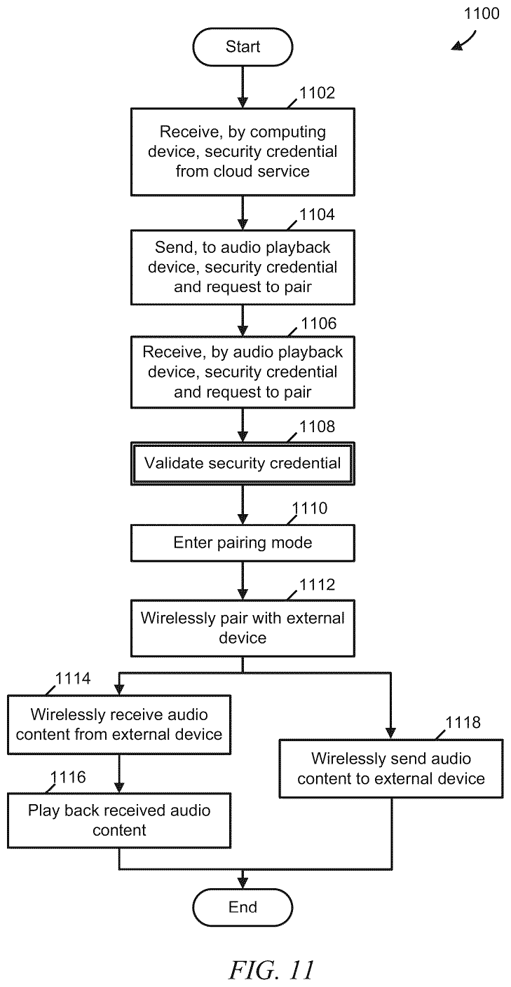

The audio playback device 110 and computing device 130 can establish such a wireless connection as disclosed herein, for instance in the examples of FIGS. 10A and 11 below. For example, a user may have possession of the computing device 130, and may wish to establish a wireless connection with the audio playback device 110. Because initiating a wireless connection may be a security-sensitive operation, some playback devices require a hardware-based control (such as a physical button press, a flip of a switch, or the like) in order to initiate pairing or another wireless connection. In particular, many Bluetooth-, Bluetooth Classic-, or BLE-enabled devices may be configured to initiate pairing via such hardware-based controls. However, in some cases, the audio playback device 110 (e.g., a soundbar, one or more speakers, or another playback device) may be wall-mounted, or may otherwise be difficult to access physically. Accordingly, the user may instead wish to use the controller 130 to instruct the playback device 110 to initiate the wireless connection (e.g., to commence pairing). The disclosed system and methods can securely initiate the wireless connection (e.g., initiate pairing mode) without requiring physical access to the audio playback device 110.

In some examples, the system 700 can make use of an existing authenticated, secure medium, such as a SONOS mobile app, another controller application, and/or one or more authenticated user accounts, to provide security while initiating the wireless connection remotely, e.g., without physical access to the playback device 110. For example, the audio playback device 110 and computing device 130 can establish a wireless connection by exchanging a security credential, such as a token, which may be associated with a user account such as an account of the playback device 110, the computing device 130, and/or the controller application executing thereon. The playback device 110 can then validate the security credential, for example by comparing the security credential to a cached security credential, sending the security credential to a cloud service for validation, or comparing the security credential with a copy of a second security credential obtained from a cloud service. For example, such a copy of a second security credential may include a copy of a token, or other credential, associated with the user account to which the playback device 110 is registered. Once the connection is established between the audio playback device 110 and computing device 130, the audio playback device 110 and computing device 130 can wirelessly exchange information, such as audio content. For example, the computing device 130 may send audio content to the audio playback device 110, and the playback device 110 can then play back the audio content.

In some examples, the system 700 can include additional audio playback devices and/or computing devices. In this example, the computing device 130 can also function as an external device; that is, in the example of FIG. 7A, the computing device 130 can send audio content to the audio playback device 110, and the audio playback device 110 can play back the received audio content. Alternatively or additionally, the computing device 130 can receive the audio content from the audio playback device 110, for example wirelessly, and can play back the received audio content, or audio content can be sent in both directions between the audio playback device 110 and computing device 130. For example, if the audio playback device 110 receives the audio content by a direct connection, such as an audio cable, from a source such as a television, it can then send the content wirelessly to an external device such as a mobile phone 130 that a user carries while moving around a home, or listens to via headphones. In the example of FIG. 7B, the system can include another external device, which can be in communication with the controller 130 and playback device 110.

FIG. 7B is a block diagram of a system 750 including a controller 130, a playback device 110, and an external device 752, in accordance with at least one embodiment of the present disclosure. As in the example of FIG. 7A, the audio playback device 110 may include a soundbar such as the ARC soundbar of SONOS, headphones, or another audio playback device (e.g., any SONOS playback device). The computing device 130 may include a mobile device or any other computing device or controller device, such as those of FIGS. 1H, 4A through 4D, and 5.

The external device 752 may include headphones, another playback device, an audio source, or any other external device. In various examples, the external device 752 may or may not be a trusted device, for example it could include a SONOS playback device or a non-SONOS playback device (e.g., another set of headphones). If the external device 752 is trusted (e.g., if the external device 752 has previously been registered via a separate pairing process with a trusted controller, such as a SONOS controller, or if the external device 752 is itself a SONOS device), it can be configured to receive a wireless connection request from the audio playback device 110 and/or the computing device 130, and to connect wirelessly in response to the request. If the external device 752 is not trusted (e.g., not a SONOS device and/or not registered with a trusted controller), it can be configured to connect with general (e.g., untrusted) devices, such as the audio playback device 110, for example via Bluetooth, Bluetooth Classic, or BLE.

For example, a user may wish to control the audio playback device 110 via the controller computing device 130, but to listen to audio content via the external device 752 instead of, or in addition to, the audio playback device 110. In order to exchange audio content between the playback device 110 and the external device 752, even if the playback device 110 and the external device 752 are not configured to trust each other (e.g., even if they are configured incompatibly, are made by different manufacturers, or cannot access a mutual cloud service), the playback device 110 and the external device 752 must establish a wireless connection. Moreover, as in the example of FIG. 7A, the audio playback device 110 may be difficult to access physically. Accordingly, as in the example of FIG. 7A, the user may wish to use the controller 130 to instruct the playback device 110 to initiate the wireless connection (e.g., to commence pairing). However, in this example, the user may then wish to establish the wireless connection (e.g., pair) between the playback device 110 and the external device 752.

In such an example, the disclosed system and methods can securely initiate the wireless connection between the playback device 110 and the external device 752 without requiring physical access to the audio playback device 110. The audio playback device 110 and external device 752 can establish this wireless connection, as disclosed herein, for instance in the examples of FIGS. 10A and 11 below. For example, the computing device 130 can send a security credential, such as a token, and a request to establish the wireless connection to the audio playback device 110. In various examples, the user account may be associated with an account of the playback device 110, the computing device 130, and/or the controller application. Accordingly, the system 750 can use an existing authenticated, secure intermediary, such as a SONOS mobile app or another controller application, to provide security while initiating the wireless connection remotely, e.g., without physical access to the playback device 110. Having received the security credential, the playback device 110 can then validate it, for example by comparing it to a cached security credential, sending it to a cloud service for validation, or comparing it with a copy of a second security credential obtained from a cloud service.

In response to successful validation of the security credential, the audio playback device 110 can enter pairing mode, and the external device 752 can subsequently pair with it. In one example, the external device 752 can also enter pairing mode in response to the user operating a hardware control of the external device 752, such as a physical button, switch, or the like. Alternatively or additionally, the external device 752 can enter pairing mode in response to a remote command, such as from the controller 130. Once both the playback device 110 and external device 752 have entered pairing mode, the connection (e.g., Bluetooth, Bluetooth Classic, or BLE) can be established between the audio playback device 110 and external device 752, and they can then wirelessly exchange audio content and/or other information. For example, the audio playback device 110 may send audio content to the external device 752, and the external device 752 (e.g., headphones) can then play back the audio content.

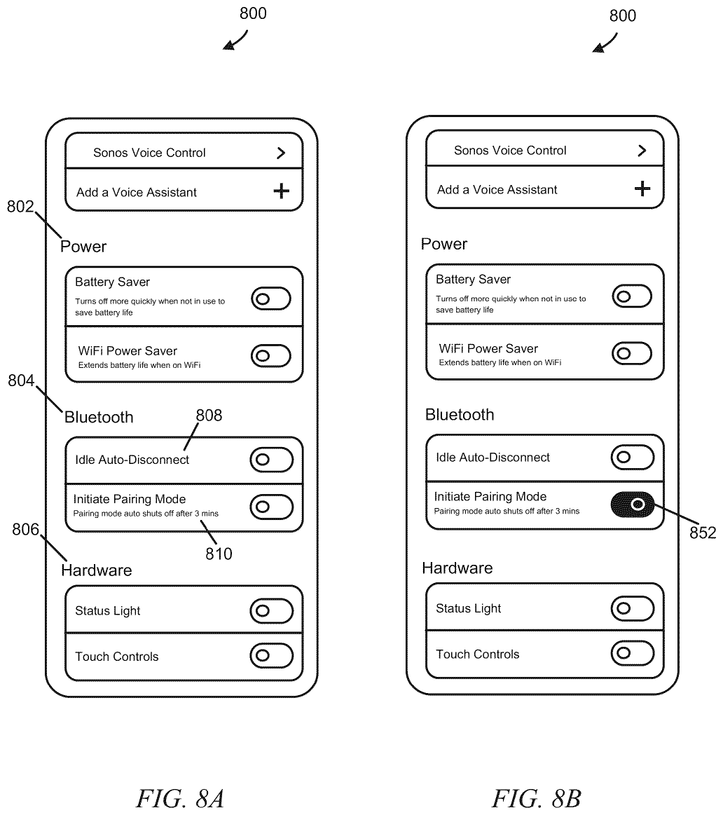

FIGS. 8A and 8B are schematic diagrams of a controller graphical user interface (GUI) 800, in accordance with at least one embodiment of the present disclosure. The GUI 800 may correspond to a controller, such as the computing devices or controllers of the examples of FIGS. 1H, 4A through 4D, 5, and 7, and/or to a controller application executing thereon. In various examples, the controller application may include a SONOS controller application (e.g., a SONOS mobile app) or another controller application, and may correspond to a user account, such as a user account of an audio playback device and/or of the controller application itself. Accordingly, the GUI 800 may enable a user to control an audio playback device, such as the playback devices described above in the examples of FIGS. 1C and 1I through 1M, FIGS. 7A and 7B, or any other audio playback device.

In some examples, the controller application can include an application that operates in the user space of the computing device. Alternatively or additionally, the controller application can include an operating system (OS) with the features of a controller, for example the controller application may be integrated into an OS of the computing device.

In the example of FIG. 8A, the user interface (UI) 800 can include a plurality of graphical controls corresponding to a plurality of options and/or settings of the controller application (e.g., for controlling an audio playback device), such as power options and/or settings 802, Bluetooth options and/or settings 804, and hardware options and/or settings 806. In various examples, the Bluetooth options 804 may include options for Bluetooth, Bluetooth Classic, and/or Bluetooth Low Energy (BLE), or may include options for another wireless connection method. The Bluetooth options can include toggles for an “Idle Auto-Disconnect” option 808 and an “Initiate Pairing” option 810. For example, the “Idle Auto-Disconnect” option 808 may cause the system to disconnect a wireless connection that is unused for at least a threshold period of time. In another example, the “Initiate Pairing” option 810 may enable the user to establish a wireless connection (e.g., to commence pairing) remotely. For example, the “Initiate Pairing” option 810 may initiate the methods disclosed herein, for instance in the examples of FIGS. 10A and 11 below.

In the example of FIG. 8B, the toggle 852 for the “Initiate Pairing” option 810 is turned on. Accordingly, the methods disclosed herein can be used to commence a wireless connection (e.g., pairing for Bluetooth, Bluetooth Classic, and/or BLE) in a controlled device, such as an audio playback device, thereby providing an opportunity to pair with another device, such as with an external device or the controller device itself. In some examples, the controller application may automatically disable the pairing mode after a threshold period of time, such as three minutes.

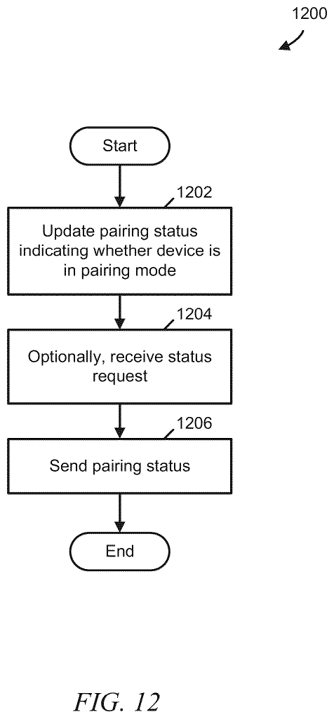

In some examples, the controlled device, such as an audio playback device, can also initiate and/or end the pairing mode in response to a hardware-based control, such as a physical button, switch, or the like. Accordingly, the displayed status of the toggle 852 for the “Initiate Pairing” option 810 can be updated based on the current status of both the hardware-based control and the GUI control, as described in the examples of FIGS. 10B and 12 below.

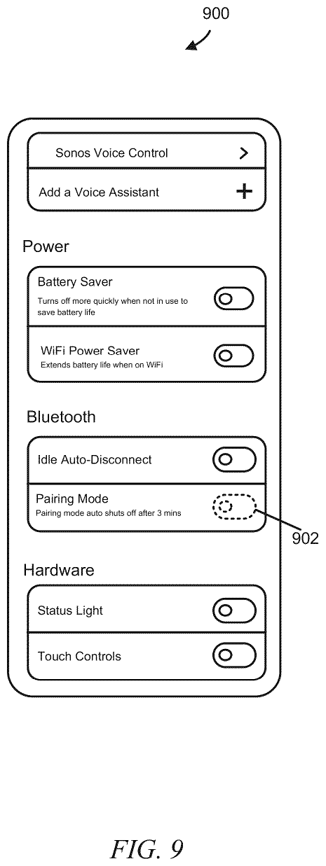

FIG. 9 is a schematic diagram of a controller GUI in a restricted mode 900, in accordance with at least one embodiment of the present disclosure. In some examples, the GUI can provide two modes, such as an administrator mode (as in the examples of FIGS. 8A and 8B) and a user mode or restricted mode 900 (as in this example).

In some examples, in the user mode or restricted mode 900, the toggle 902 for the “Initiate Pairing” option may not be displayed, and/or the “Initiate Pairing” option 810 itself may not be displayed. For example, in the case that a user is not authenticated (e.g., the user is not logged into an authenticated user account) or the device is unsupported, the controller GUI may operate in the restricted mode 900, and accordingly may not display the toggle 902.

In another example, as shown in FIG. 9, in the user mode or restricted mode 900, the toggle 902 for the “Initiate Pairing” option shows the current status of the “Initiate Pairing” option 810. However, the toggle 902 is disabled, that is, it cannot be changed from within the user mode or restricted mode 900. By contrast, in the administrator mode, the toggle 852 for the “Initiate Pairing” option 810 can be enabled, as shown in the example of FIGS. 8A and 8B above.

FIG. 10A is a sequence diagram 1000 showing interactions among a computing device 130, cloud service 1002, audio playback device 110, and external device 752 while initiating remote audio pairing, in accordance with at least one embodiment of the present disclosure. As described herein, the audio playback device 110 may include a soundbar such as the ARC soundbar of SONOS, as described above in the examples of FIGS. 7A and 7B, headphones, another speaker or audio transducer (e.g., a SONOS speaker or audio transducer), another playback device (e.g., any SONOS playback device), such as those of the examples of FIGS. 1C and 1I through 1M, or any other audio playback device. The computing device 130 may include any mobile device, such as a mobile phone, smartphone, tablet computer, personal music player, or any other computing device, such as those of the examples of FIGS. 1H, 4A through 4D, and 5. In some examples, the computing device 130 can execute a controller application, such as a SONOS mobile app, or another controller application. The external device 752 may include headphones, as described above in the examples of FIG. 7B, a SONOS playback device, an audio source, or any other external device. In various examples, the external device may or may not be a trusted device.

In some examples, the controller application can include an application that operates in the user space of the computing device. Alternatively or additionally, the controller application can include an OS with the features of a controller, for example the controller application may be integrated into an OS of the computing device.

In some examples, the external device can be the computing device executing the controller application.

For example, as shown in sequence diagram 1000, the sequence can begin when the computing device 130 executing a controller application receives a credential 1004 (e.g., a security credential) from the cloud service 1002 (e.g., as a result of an authentication process). For example, the credential 1004 may include a security token or another credential or security credential. The security credential 1004 can be associated with a user account linked to the audio playback device. Alternatively or additionally, the user account can be associated with the controller application.

The audio playback device 110 can then receive, from the computing device 130, a request to enter a pairing mode and a security credential 1006. The security credential can be associated with a user account. The user account, in turn, can be authorized to initiate the pairing operation on the playback device.

In various examples, the user account may be associated with the audio playback device 110 or the controller application executed by the computing device 130. For example, the controller application could be a SONOS mobile app, and the user account could be a user account belonging to the owner of the computing device 130, the owner of the audio playback device 110, or both. Note that, in some examples, any user account that is authorized to initiate pairing on the playback device may do so.

In some examples, the degree of permission the controller application possesses for controlling the audio playback device 110 or the external device 752 may vary. For example, the mode of the controller application (e.g., the user or restricted mode 900 or the administrator or unrestricted mode described in the examples of FIGS. 8A, 8B, and 9) may depend on whether the user account is associated with the audio playback device 110, the controller application of computing device 130, or both, and/or on the validation of the security credential, as described below. For example, in a case where the user account used by the controller application does not have sufficient permission to initiate pairing with the playback device, the controller application can operate in the restricted mode described in FIG. 9.

In some examples, the request to enter the pairing mode and the security credential 1006 are transmitted via a local area network (LAN) or personal area networks (PANs) other than Bluetooth (such as wireless USB, infrared communications, near-field communication (NFC), or wireless ad hoc network), as described in the examples of FIGS. 7A and 7B. For example, once the security credential is validated, the method 1000 may not require access to the Internet or other external networks or communication channels in order to establish a wireless connection remotely, for example, to use the computing device 130 and/or controller application to instruct the audio playback device 110 to enter pairing mode. Instead, the disclosed system and methods can make use of a secure, trusted intermediary (e.g., the computing device 130, controller application, and/or the user account) in order to initiate pairing. Accordingly, the disclosed system and methods can be even more secure than a hardware-based control to establish a wireless connection (e.g., to initiate pairing), and may reduce potential attack surfaces (e.g., attack surfaces via the Internet or other external networks) by sending the request to enter pairing mode via local or personal area networks only.

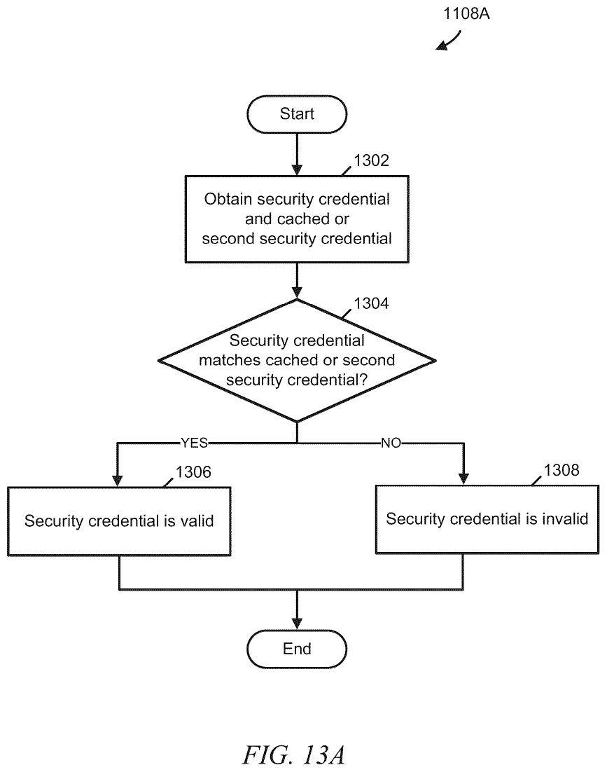

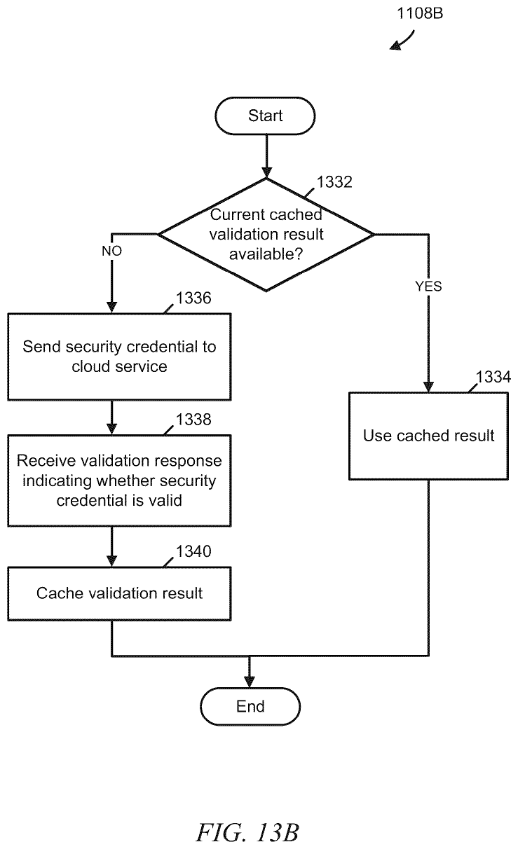

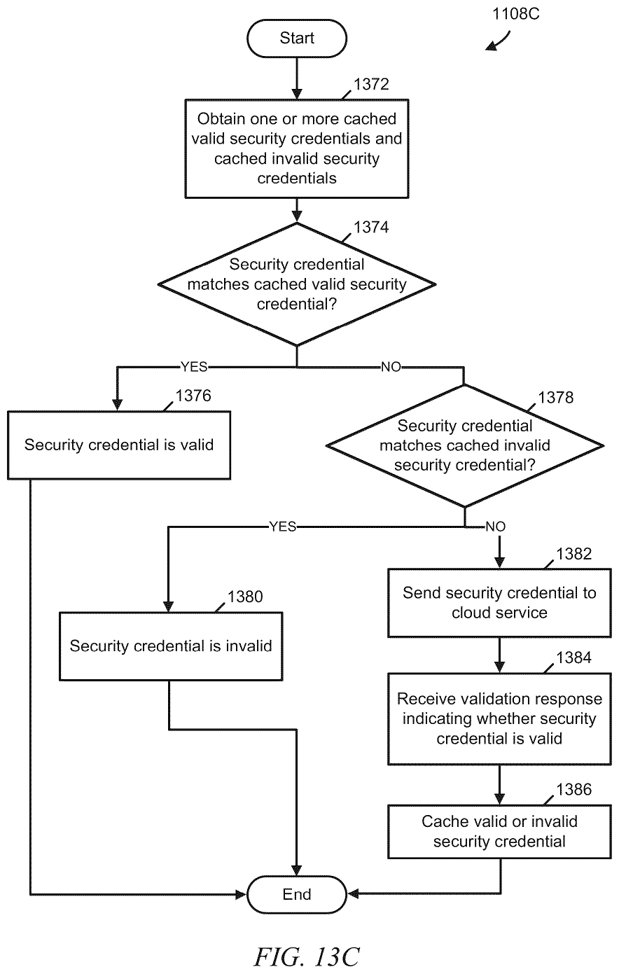

The audio playback device 110 can then validate 1008 the security credential. Validating 1008 the security credential will be described in greater detail in the examples of FIGS. 10C through 10D and 13A through 13C below.

In some examples, the mode of the controller application (as in the example of FIG. 9) may depend on the validation 1008 of the security credential.

Based on the credential being valid, the audio playback device 110 can then enter the pairing mode and wirelessly pair 1010 with the external device 752. In some examples, the pairing mode can be a Bluetooth pairing mode, Bluetooth Classic pairing mode, or Bluetooth Low Energy (BLE) pairing mode. For example, the established connection between the playback device 110 and external device 752 may utilize standard Bluetooth, Bluetooth Classic, or BLE connection parameters.

In various examples, actually pairing 1010 may be initiated by either end of the connection. For example, once both the audio playback device 110 and the external device 752 have entered pairing mode, the external device 752 can initiate wireless pairing 1010. For example, the wireless (e.g., Bluetooth, Bluetooth Classic, or BLE) connection 1010 can be initiated via an application (such as a native Bluetooth, Bluetooth Classic, or BLE app) on the external device 752. In another example, the computing device 130, controller application, and/or audio playback device 110 can initiate the wireless pairing 1010. For example, the computing device 130, controller application, and/or audio playback device 110 may manage a paired list, enabling a user to choose among previously paired source devices to connect, thereby initiating the wireless connection 1010.

Once paired, the audio playback device can wirelessly send audio content 1012, for example an audio stream, to the at least one external device (for example, if the external device includes headphones or another playback device). Alternatively, the audio playback device can wirelessly receive audio content 1012 from the at least one external device (for example, if the external device is an audio source), or audio content 1012 can be sent in both directions between the audio playback device and external device.

In examples where the pairing mode is a Bluetooth or BLE pairing mode, the audio playback device can wirelessly receive the audio content 1012 via Bluetooth or BLE from the at least one external device. Likewise, the audio playback device can wirelessly send the audio content 1012 to the at least one external device via Bluetooth or BLE.

In case the audio playback device wirelessly received the audio content 1012, the audio playback device can then play back 1014 the audio content (e.g., an audio stream).

It should also be noted that the example sequence diagram as shown in FIG. 10A is provided by way of example only. In actual implementation, the order of various sequence steps can be altered, one or more sequence steps can be combined, and other similar changes can be included.

FIG. 10B is a sequence diagram 1030 showing interactions between a computing device 130 and audio playback device 110 while refreshing a status of remote audio pairing, in accordance with at least one embodiment of the present disclosure.

As illustrated in the examples of FIGS. 8A and 8B above, the UI 800 of the computing device 130 and/or the controller application executing thereon can provide an interface to control the audio playback device 110 (e.g., by modifying the options and/or settings 804), and can also display the current status of the options and/or settings 804. For example, the display of the GUI 800 can immediately reflect updates to the options and/or settings 804 that a user makes through the UI 800. However, in some examples, it may be important for the GUI 800 to immediately reflect updates the user makes by other mechanisms, for example manually via hardware controls of the audio playback device 110. Accordingly, in this example, the audio playback device 110 and/or the UI 800 can refresh the pairing status of the audio playback device 110 to include changes made via hardware controls.

For example, as shown in sequence diagram 1030, the sequence can begin when the audio playback device 110 updates a pairing status 1032. For example, the updated pairing status 1032 can indicate whether the audio playback device is in a pairing mode. For example, in response to a user's operation of a hardware control that initiates pairing in the audio playback device 110 (e.g., a physical button press, a flip of a switch, or the like, that initiates pairing), the audio playback device 110 can update the pairing status 1032.

In some examples, the audio playback device 110 can alternatively or additionally update the pairing status 1032 based on remote instructions to initiate or terminate the pairing mode, as disclosed herein. In another example, the audio playback device 110 may update the pairing status 1032 based on a time, for example it may update the pairing status 1032 at specific times or at regular intervals of time.

The computing device 130 can then optionally send a pairing status request 1034 to the audio playback device 110. For example, the computing device 130 can send the status request 1034 in order to update the status displayed in a UI of the controller application, as illustrated in the examples of FIGS. 8A, 8B, and 9.

Note that, in some examples, the computing device 130 does not send the pairing status request 1034. For example, the computing device 130 may only send the pairing status request 1034 if it uses polling of the audio playback device 110 to seek updates. In some examples, the computing device 130 can instead use subscriptions and/or events to receive updates from the audio playback device 110, and accordingly the computing device 130 may not send the pairing status request 1034. Alternatively or additionally, the audio playback device 110 may send the pairing status automatically, for example the audio playback device 110 may send an event including the pairing status in response to updating the status 1032.

The audio playback device 110 can then send the pairing status 1036 to the computing device 130. The pairing status 1036 can indicate whether the audio playback device is currently in the pairing mode.

In some examples, the audio playback device 110 may send the pairing status 1036 to the computing device 130 in response to a subscription. Alternatively or additionally, the audio playback device 110 may send the pairing status 1036 via events, for example it may send an event to computing device 130 including the pairing status in response to updating the status 1032.

In examples where polling is used, the audio playback device 110 may send the pairing status 1036 to the computing device 130 in response to the pairing status request 1034 received from the computing device 130.

The computing device 130 may display the updated status 1036 in a UI (e.g., a GUI) of the controller application, as illustrated in the examples of FIGS. 8A, 8B, and 9.

FIG. 10C is a sequence diagram 1008A showing interactions between a cloud service 1002 (e.g., at least one cloud server) and an audio playback device 110 while validating a remote audio pairing security credential, in accordance with at least one embodiment of the present disclosure.

In this example, the audio playback device 110 may be registered to a second user account with the cloud service 1002.

For example, as shown in sequence diagram 1008A, the sequence can begin when the audio playback device 110 sends the security credential 1062 to the cloud service 1002. In some examples, the cloud service 1002 can recognize the received request (e.g., the security credential 1062) as being associated with the second user account. For example, the request may be part of a session associated with the second user account.

Accordingly, the cloud service 1002 can evaluate whether the security credential is valid, for example the cloud service 1002 can validate the token or other security credential. In some examples, the cloud service 1002 may make use of another identity provider to validate the token or security credential.

The audio playback device 110 can then receive, from the cloud service 1002, a validation response 1064 indicating whether the security credential is valid.

FIG. 10D is a sequence diagram 1008B showing interactions between a cloud service 1002 (e.g., at least one cloud server) and audio playback device 110 while validating a remote audio pairing security credential, in accordance with at least one embodiment of the present disclosure.

In this example, the audio playback device 110 may be registered to a second user account with the cloud service 1002.

For example, as shown in sequence diagram 1008B, the sequence can begin when the audio playback device 110 obtains, from the cloud service 1002, a copy of a second security credential 1082 associated with the second user account. For example, the copy of the second security credential 1082 may include a copy of a token, or other credential, associated with the user account to which the playback device 110 is registered.

The audio playback device 110 can then compare 1084 the security credential with the second security credential obtained from the cloud service 1002. If the security credential matches the second security credential, the playback device can determine that the security credential is valid. If the security credential fails to match the second security credential, the playback device can determine that the security credential is invalid.

In some examples, the degree of permission the controller application possesses for controlling the audio playback device 110 or the external device 752 may depend on whether the user account is associated with the audio playback device 110, the controller application of computing device 130, or both, and/or on the validation of the security credential. For example, the mode of the controller application may depend on such permissions, and may correspond to the user controls and/or information displayed by a UI of the controller application, as described above in the example of FIG. 9.

FIG. 11 illustrates an example process flow 1100 performed by a system including a computing device and an audio playback device, in initiating remote audio pairing, in accordance with at least one embodiment of the present disclosure. In some examples, the system may also include an external device and/or a cloud service.

For example, the audio playback device may include a soundbar such as the ARC soundbar of SONOS, as described above in the examples of FIGS. 7A and 7B, headphones, another speaker or audio transducer (e.g., a SONOS speaker or audio transducer), another playback device (e.g., any SONOS playback device), such as those of the examples of Figures IC and II through IM, or any other audio playback device. The computing device may include any mobile device, such as a mobile phone, smartphone, tablet computer, personal music player, or any other computing device, such as those of the examples of FIGS. 1H, 4A through 4D, and 5. In some examples, the computing device can execute a controller application, such as a SONOS mobile app, or another controller application. The computing device may also be referred to as a controller. The external device may include headphones, as described above in the example of FIG. 7B, a SONOS playback device, an audio source, or any other external device. In various examples, the external device may or may not be a trusted device of the audio playback device. In some examples, the external device can be the computing device executing the controller application, as in the example of FIG. 7A above. In some examples, there may be multiple external devices, for example, multiple speakers or other playback devices. In such a case, the steps of the method 1100 involving the external device may be repeated for each external device.

Initiating remote audio pairing 1100 is described further in the example of FIG. 10A above.

As shown in FIG. 11, the process 1100 can begin when the computing device receives 1102 a security credential from a cloud service. The security credential can be associated with a user account, as described above. In an example, the user account may be a user account of the cloud service, and may be associated with the audio playback device and/or with the controller application. For example, the security credential may be a token.

The computing device can then send 1104 the security credential and a request to establish a wireless connection (e.g., to enter a Bluetooth, Bluetooth Classic, or BLE pairing mode) to the audio playback device.

The audio playback device can receive 1106 the request to connect wirelessly and the security credential from the computing device.

The audio playback device can then validate 1108 the security credential, for example by comparing it to an example of a valid security credential, such as a cached security credential or a copy of a security credential obtained from a cloud service. Validating 1108 the security credential is described in greater detail in the examples of FIGS. 10C and 10D above, and 13A through 13C below.

Based on the security credential being valid, the audio playback device can then establish the wireless connection with the external device. For example, in the case of Bluetooth, Bluetooth Classic, or BLE, the audio playback device can enter 1110 a pairing mode. While in the pairing mode, the audio playback device can then wirelessly pair 1112 with the at least one external device.

For example, in the case of Bluetooth, Bluetooth Classic, or BLE, the external device can also enter a pairing mode. For example, the external device can enter pairing mode in response to a user activating a hardware-based pairing control and/or another remote command, such as a command received from the computing device and/or the controller application.

In various examples, the actual pairing can be initiated by either end of the connection. For example, once both the audio playback device and the external device have entered pairing mode, the external device can initiate the wireless pairing 1112. For example, the wireless (e.g., Bluetooth, Bluetooth Classic, or BLE) connection can be initiated via an application (such as a native Bluetooth, Bluetooth Classic, or BLE app) on the external device. In another example, the computing device, controller application, and/or audio playback device can initiate the wireless pairing 1112. For example, the computing device, controller application, and/or audio playback device may manage a paired list, enabling a user to choose among previously paired source devices to connect, thereby initiating the wireless connection.

In the case that the external device is the computing device, as in FIG. 7A above, the audio playback device can establish the wireless connection with the computing device. For example, in the case of Bluetooth, Bluetooth Classic, or BLE, the computing device may enter the pairing mode, for example when the computing device sends the request to the playback device, and/or in response to sending the request to the playback device. The audio playback device and the computing device may then pair.

After wirelessly pairing with the at least one external device, the audio playback device can send audio content (e.g., an audio stream) to the external device (e.g., if the external device is headphones or another playback device), and/or can receive audio content (e.g., an audio stream) from the external device for playback.

For example, the audio playback device can wirelessly send 1118 audio content (e.g., an audio stream) to the at least one external device. For example, in the case of Bluetooth, Bluetooth Classic, or BLE, the playback device can wirelessly send 1118 audio content via Bluetooth, Bluetooth Classic, or BLE, respectively, using the established wireless connection. The external device may play back the audio content for the user. In some cases, sending 1118 the audio content may be controlled by a UI other than the UI 800, for example a separate UI in the computing device and/or a separate UI of the controller application.

Alternatively or additionally, the audio playback device can wirelessly receive 1114 audio content (e.g., a stream) from the at least one external device, via the established wireless connection. For example, in the case of Bluetooth, Bluetooth Classic, or BLE, the playback device can wirelessly receive 1114 audio content via Bluetooth, Bluetooth Classic, or BLE, respectively. The audio playback device can then play back 1116 the received audio content. In some cases, receiving 1114 the audio content may be controlled by a UI other than the UI 800, for example a separate UI in the computing device and/or a separate UI of the controller application.

The method 1100 may then end.

FIG. 12 illustrates an example process flow 1200 performed by a computing device and audio playback device in refreshing a status of remote audio pairing, in accordance with at least one embodiment of the present disclosure. The process 1200 as shown in FIG. 12 can be performed by an audio playback device and/or a computing device, such as the audio playback device 110 and/or the computing device 130, as described above.

As discussed in the example of FIG. 10B, the audio playback device 110 and/or the UI 800 may use the method 1200 to refresh the pairing status of the audio playback device 110, thereby including changes made via hardware controls of the audio playback device 110. For example, the UI 800 of the computing device 130 and/or the controller application can use the method 1200 to display the current status of options and/or settings related to wireless connection (e.g., pairing), such as the options and/or settings 804, including updates the user makes manually via hardware controls.

As shown in FIG. 12, the process 1200 can begin when the audio playback device updates 1202 a pairing status indicating whether the audio playback device is in a pairing mode. For example, the audio playback device may update 1202 the pairing status in response to a user's operation of a hardware control that initiates and/or terminates pairing, such as a physical button press, a flip of a switch, or the like. In some examples, the playback device can alternatively or additionally update 1202 the pairing status based on remote instructions to initiate or terminate the pairing mode, such as the request to pair described above in FIG. 11. In another example, the playback device may update 1202 the pairing status at specific times or at regular intervals of time.

The audio playback device can then optionally receive 1204 a pairing status request from the computing device. For example, the computing device can send the status request in order to update the status displayed in the UI of the controller application, as illustrated in the examples of FIGS. 8A, 8B, and 9.

Alternatively, in some examples, the playback device may not receive 1204 the pairing status request. For example, the playback device may only receive 1204 the pairing status request if the computing device uses polling of the playback device to seek updates. In some examples, the computing device can instead use subscriptions and/or events to receive updates from the playback device, and accordingly the playback device may not receive 1204 the pairing status request. For example, the playback device may send the pairing status indicator (as described below in operation 1206) in response to a subscription and/or as an event.

The audio playback device can then send 1206 the pairing status to the computing device. The pairing status can indicate whether the audio playback device is currently in the pairing mode.

For example, the playback device may send the pairing status indicator (as described below in operation 1206) in response to a subscription and/or as an event. For example, the playback device may send an event including the pairing status, for example in response to updating the pairing status in operation 1202. In an example, a user may activate a hardware control (e.g., by pushing a button) that toggles the pairing mode, and in response to the same, the playback device may wirelessly transmit 1206 a pair status indicator to connected and/or trusted devices. For example, the playback device can transmit 1206 the pair status indicator to devices, such as the computing device, that subscribe to updates from the playback device.

Alternatively or additionally, in some examples, polling is used, and accordingly the audio playback device may send 1206 the pairing status to the computing device in response to the pairing status request received from the computing device in operation 1204.

Accordingly, the computing device may display the updated status in a UI (e.g., a GUI) of the controller application, as described above in the examples of FIGS. 8A, 8B, and 9.

The method 1200 may then end.

FIGS. 13A-13C illustrate example process flows performed by a cloud service and audio playback device in validating a remote audio pairing security credential, in accordance with at least one embodiment of the present disclosure. The processes as shown in FIGS. 13A-13C can be performed by, for example, the cloud service 1002 and the audio playback device 110, as described above. In an example, as described above, the security credential may include a security token, and/or another security credential. The security credential may be associated with a user account, and the user account can be associated with at least one of the audio playback device or a controller application executing thereon.

FIG. 13A illustrates a more specific example process flow 1108A of the flow 1100 of additional process steps used to validate a remote audio pairing security credential. As shown in FIG. 13A, the process 1108A can begin when the playback device obtains 1302 the security credential and a cached security credential or another security credential, such as a second security credential or a copy of a second security credential associated with a second user account.

As described above, the playback device may receive the security credential from the computing device 130, for example via a LAN (e.g., the network 104 of FIG. 1B) or PAN.

In an example, the cached security credential can be a cached token or other cached security credential of the playback device. For example, the cached security credential can be a known and/or trusted example of a valid security credential. In another example, the playback device may obtain 1302 a copy of a second security credential associated with the second user account from at least one cloud server of a cloud service. For example, the copy of the second security credential may include a copy of a token, or other credential, associated with the user account to which the playback device is registered.

The playback device can then determine 1304 whether the security credential matches the cached security credential. If the security credential matches the cached security credential, the playback device can determine 1306 that the security credential is valid. If the security credential fails to match the cached security credential, the playback device can determine 1308 that the security credential is invalid.

Note that, in some examples, the playback device may maintain a cache with both valid and invalid credentials. In such examples, the playback device may compare the security credential to the valid and invalid credentials, and may send the security credential for validation by the cloud service if it fails to match either, as described in the example of FIG. 13C below.

The process 1108A can then end.

FIG. 13B illustrates a more specific example process flow 1108B of the flow 1100 of additional process steps used to validate a remote audio pairing security credential. As described above, the received security credential may be associated with a user account, and the user account can be associated with at least one of the audio playback device or a controller application executing on the audio playback device. In this example, the audio playback device can be registered to a second user account with at least one cloud server of a cloud service, such as the cloud service 1002 of the examples of FIGS. 10A-10D above.

As shown in FIG. 13B, the process 1108B can begin when the playback device determines 1332 whether an up-to-date cached validation result is available. For example, the cached result may be the result of a previous cloud service validation. In some examples, the cached result may only remain valid for a limited interval, such as a period of time (e.g., a number of minutes, hours, days, weeks, or months), or a maximum number of uses. Accordingly, if the cached result is older than the interval, the playback device may discard the cached result and proceed to operation 1336. Conversely, if the cached result is up-to-date, the playback device may proceed to operation 1334.

Responsive to an up-to-date cached validation result being available, the playback device can then use 1334 the cached result. The process 1108B can then end.

Responsive to an up-to-date cached validation result not being available, the playback device can then send 1336 the security credential to at least one cloud server of the cloud service.

The playback device can then receive 1338 a validation response from the cloud service indicating whether the security credential is valid.

The playback device can then cache 1340 the validation result for future use, for example as described above with respect to the operations 1332 and 1334.

The process 1108B can then end.

FIG. 13C illustrates a more specific example process flow 1108C of the flow 1100 of additional process steps used to validate a remote audio pairing security credential. As described above, the received security credential may be associated with a user account, and the user account can be associated with at least one of the audio playback device or a controller application executing on the audio playback device. In this example, the audio playback device can be registered to a second user account with at least one cloud server of a cloud service, such as the cloud service 1002 of the examples of FIGS. 10A-10D above.

In the example of FIG. 13C, the playback device may maintain a cache with both valid and invalid credentials, and may compare the security credential to the valid and invalid credentials. If the playback device cannot ascertain the validity of the security credential based on these cached credentials, it may instead send the security credential for validation by the cloud service, as described below.

As shown in FIG. 13C, the process 1108C can begin when the playback device obtains 1372 one or more cached valid security credentials and cached invalid security credentials.

The playback device can then determine 1374 whether the security credential matches one or more of the cached valid security credentials. For example, the playback device can compare the security credential to the one or more cached valid security credentials and determine 1374 whether the security credential is identical to one or more of the cached valid security credentials.

Responsive to the security credential matching one or more of the cached valid security credentials, the playback device can then determine 1376 that the security credential is valid. The process 1108C can then end.

Responsive to the security credential not matching one or more of the cached valid security credentials, the playback device can then determine 1378 whether the security credential matches one or more of the cached invalid security credentials. For example, the playback device can compare the security credential to the one or more cached invalid security credentials and determine 1378 whether the security credential is identical to one or more of the cached invalid security credentials.

Responsive to the security credential matching one or more of the cached invalid security credentials, the playback device can then determine 1380 that the security credential is invalid. The process 1108C can then end.

Responsive to the security credential not matching one or more of the cached invalid security credentials, the playback device may request the cloud service to validate the security credential, similarly to the example of FIG. 13B. For example, responsive to the security credential not matching, the playback device may then send 1382 the security credential to at least one cloud server of the cloud service.

The playback device can then receive 1384 a validation response from the cloud service indicating whether the security credential is valid.

The playback device can then cache 1386 the security credential for future use. For example, if the validation response received from the cloud service indicates the security credential is valid, the playback device can cache 1386 the security credential as a valid credential among the one or more cached valid security credentials. If the validation response received from the cloud service indicates the security credential is invalid, the playback device can cache 1386 the security credential as an invalid credential among the one or more cached invalid security credentials. In some examples, the cached security credential may only remain valid for a limited interval, such as a period of time (e.g., a number of minutes, hours, days, weeks, or months), or a maximum number of uses.

The process 1108B can then end.

### V. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VI. Example Features

The following examples pertain to further embodiments, from which numerous permutations and configurations will be apparent.

(Feature 1). An audio playback device comprising at least one audio transducer; at least one communication interface; at least one processor; and at least one non-transitory computer-readable medium comprising program instructions that are executable by the at least one processor. The instructions are executable by the at least one processor such that the audio playback device is configured to detect, from a computing device executing a controller application, a request to enter a pairing mode and a security credential associated with a user account. The user account can be associated with at least one of the audio playback device or the controller application. The instructions are further executable by the at least one processor such that the audio playback device is configured to validate the security credential. The instructions are further executable by the at least one processor such that the audio playback device is configured, based on the credential being valid, to enter the pairing mode, wirelessly pair with an external device, and wirelessly detect audio content from the at least one external device and play back the audio content, or wirelessly send audio content to the at least one external device.

(Feature 2). The audio playback device of feature 1, wherein the at least one non-transitory computer-readable medium further comprises program instructions that are executable by the at least one processor such that the audio playback device is configured to: update, based on a button, a switch, or another control of the audio playback device, a pairing status indicating whether the audio playback device is in the pairing mode; detect a status request from the computing device executing the controller application; and send, to the computing device executing the controller application, the pairing status indicating whether the audio playback device is in the pairing mode.

(Feature 3). The audio playback device of either feature 1 or feature 2, wherein: the pairing mode comprises a Bluetooth pairing mode or Bluetooth Low Energy (BLE) pairing mode; to wirelessly detect the audio content comprises to detect the audio content via Bluetooth or BLE; and to wirelessly send the audio content comprises to send the audio content via Bluetooth or BLE.

(Feature 4). The audio playback device of any of features 1-3, wherein to detect the request to enter the pairing mode and the security credential comprises to detect the request to enter the pairing mode and the security credential via a local or personal area network.

(Feature 5). The audio playback device of any of features 1-4, wherein to validate the security credential comprises to: compare the security credential to a cached security credential; and determine whether the security credential matches the cached security credential.

(Feature 6). The audio playback device of any of features 1-5, wherein: the audio playback device is registered to a second user account with at least one cloud server; and to validate the security credential comprises to: send the security credential to the at least one cloud server and detect a validation response indicating whether the security credential is valid; or obtain, from the at least one cloud server, a copy of a second security credential associated with the second user account and compare the security credential with the second security credential.

(Feature 7). The audio playback device of any of features 1-6, wherein the security credential being valid is further based on the user account being authorized to initiate the pairing mode.

(Feature 8). The audio playback device of any of features 1-7, wherein the computing device executing the controller application comprises the at least one external device.

(Feature 9). The audio playback device of any of features 1-8, wherein the security credential comprises a security token.

(Feature 10). The audio playback device of any of features 1-9, wherein the audio playback device comprises a soundbar.

(Feature 11). The audio playback device of any of features 1-9, wherein the audio playback device comprises headphones.

(Feature 12). A system comprising: a computing device comprising: a communication interface; at least one processor; and at least one non-transitory computer-readable medium comprising instructions of a controller application, the instructions being executable by the at least one processor such that the computing device is configured to: detect a security credential from a cloud service, wherein the security credential is associated with a user account, and the user account is associated with at least one of an audio playback device or the controller application; and send, to the audio playback device, the security credential and a request to enter a pairing mode; and the audio playback device comprising: at least one audio transducer; a communication interface; at least one processor; and at least one non-transitory computer-readable medium comprising program instructions that are executable by the at least one processor such that the audio playback device is configured to: detect, from the computing device, the request to enter the pairing mode and the security credential; validate the security credential; based on the security credential being valid: enter the pairing mode; while in the pairing mode, wirelessly pair with at least one external device; and after wirelessly pairing with the at least one external device: wirelessly detect audio content from the at least one external device, and play back the audio content; or wirelessly send audio content to the at least one external device.

(Feature 13). The system of feature 12, wherein: the at least one non-transitory computer-readable medium of the computing device further comprises program instructions of the controller application that are executable by the at least one processor of the computing device such that the computing device is configured to send a status request to the audio playback device; and the at least one non-transitory computer-readable medium of the audio playback device further comprises program instructions that are executable by the at least one processor of the audio playback device such that the audio playback device is configured to: update, based on a button, a switch, or another controller belonging to the audio playback device, a pairing status indicating whether the audio playback device is in the pairing mode; and send, to the computing device, the pairing status indicating whether the audio playback device is in the pairing mode.

(Feature 14). The system of feature 12 or feature 13, wherein: the pairing mode comprises a Bluetooth pairing mode or Bluetooth Low Energy (BLE) pairing mode; to wirelessly detect the audio content comprises to detect the audio content via Bluetooth or BLE; and to wirelessly send the audio content comprises to send the audio content via Bluetooth or BLE.

(Feature 15). The system of any of features 12-14, wherein the security credential being valid is further based on the user account being authorized to initiate the pairing mode.

(Feature 16). The system of any of features 12-15, wherein the computing device comprises the at least one external device.

(Feature 17). The system of any of features 12-16, wherein the at least one non-transitory computer-readable medium of the computing device further comprises instructions of the controller application that are executable by the at least one processor of the computing device such that the computing device is configured to display, according to a privilege level, a user interface (UI) of the controller application in a first mode or a second mode.

(Feature 18). The system of any of features 12-17, wherein the security credential comprises a security token.

(Feature 19). The system of any of features 12-18, wherein the audio playback device comprises a soundbar.

(Feature 20). The system of any of features 12-18, wherein the audio playback device comprises headphones.

(Feature 21). A computing device comprising: a communication interface; at least one processor; and at least one non-transitory computer-readable medium comprising instructions of a controller application, the instructions being executable by the at least one processor such that the computing device is configured to: detect a security credential from a cloud service, wherein the security credential is associated with a user account, and the user account is associated with at least one of an audio playback device or the controller application; and send, to the audio playback device, the security credential and a request to enter a pairing mode.

(Feature 22). The computing device of feature 21, wherein the at least one non-transitory computer-readable medium further comprises instructions of the controller application that are executable by the at least one processor such that the computing device is configured to: retrieve a pairing status from the audio playback device, wherein: the audio playback device is configured to update the pairing status based on a button, a switch, or another controller belonging to the audio playback device; and the pairing status indicates whether the audio playback device is in the pairing mode; and display the pairing status via a user interface (UI) of the controller application.

(Feature 23). The computing device of feature 21 or feature 22, wherein to send the security credential and the request to enter the pairing mode comprises to send the security credential and the request to enter the pairing mode via a local or personal area network.

(Feature 23). The computing device of any of features 21-23, wherein the at least one non-transitory computer-readable medium further comprises instructions of the controller application that are executable by the at least one processor such that the computing device is configured to display, according to a privilege level, a user interface (UI) of the controller application in a first mode or a second mode.

1. An audio playback device comprising:
at least one audio transducer;
at least one communication interface;
at least one processor; and
at least one non-transitory computer-readable medium comprising program instructions that are executable by the at least one processor such that the audio playback device is configured to:
detect, from a computing device executing a controller application:
a request to enter a pairing mode; and
a security credential associated with a user account, wherein the user account is associated with at least one of the audio playback device or the controller application;
validate the security credential;
based on the security credential being valid:
enter the pairing mode;
while in the pairing mode, wirelessly pair with at least one external device; and
after wirelessly pairing with the at least one external device:
wirelessly detect audio content from the at least one external device, and play back the audio content; or
wirelessly send audio content to the at least one external device.

2. The audio playback device of claim 1, wherein the at least one non-transitory computer-readable medium further comprises program instructions that are executable by the at least one processor such that the audio playback device is configured to:
update, based on a button, a switch, or another control of the audio playback device, a pairing status indicating whether the audio playback device is in the pairing mode;
detect a status request from the computing device executing the controller application; and
send, to the computing device executing the controller application, the pairing status indicating whether the audio playback device is in the pairing mode.

3. The audio playback device of claim 1, wherein:
the pairing mode comprises a Bluetooth pairing mode or Bluetooth Low Energy (BLE) pairing mode;
to wirelessly detect the audio content comprises to detect the audio content via Bluetooth or BLE; and
to wirelessly send the audio content comprises to send the audio content via Bluetooth or BLE.

4. The audio playback device of claim 1, wherein to detect the request to enter the pairing mode and the security credential comprises to detect the request to enter the pairing mode and the security credential via a local or personal area network.

5. The audio playback device of claim 1, wherein to validate the security credential comprises to:
compare the security credential to a cached security credential; and
determine whether the security credential matches the cached security credential.

6. The audio playback device of claim 1, wherein:
the audio playback device is registered to a second user account with at least one cloud server; and
to validate the security credential comprises to:
send the security credential to the at least one cloud server and detect a validation response indicating whether the security credential is valid; or
obtain, from the at least one cloud server, a copy of a second security credential associated with the second user account and compare the security credential with the second security credential.

7. The audio playback device of claim 1, wherein the security credential being valid is further based on the user account being authorized to initiate the pairing mode.

8. The audio playback device of claim 1, wherein the computing device executing the controller application comprises the at least one external device.

9. The audio playback device of claim 1, wherein the security credential comprises a security token.

10. The audio playback device of claim 1, wherein the audio playback device comprises a soundbar.

11. A system comprising:
a computing device comprising:
a communication interface;
at least one processor; and
at least one non-transitory computer-readable medium comprising instructions of a controller application, the instructions being executable by the at least one processor such that the computing device is configured to:
detect a security credential from a cloud service, wherein the security credential is associated with a user account, and the user account is associated with at least one of an audio playback device or the controller application; and
send, to the audio playback device, the security credential and a request to enter a pairing mode; and
the audio playback device comprising:
at least one audio transducer;
a communication interface;
at least one processor; and
at least one non-transitory computer-readable medium comprising program instructions that are executable by the at least one processor such that the audio playback device is configured to:
detect, from the computing device, the request to enter the pairing mode and the security credential;
validate the security credential;
based on the security credential being valid:
enter the pairing mode;
while in the pairing mode, wirelessly pair with at least one external device; and
after wirelessly pairing with the at least one external device:
wirelessly detect audio content from the at least one external device, and play back the audio content; or
wirelessly send audio content to the at least one external device.

12. The system of claim 11, wherein:
the at least one non-transitory computer-readable medium of the computing device further comprises program instructions of the controller application that are executable by the at least one processor of the computing device such that the computing device is configured to send a status request to the audio playback device; and
the at least one non-transitory computer-readable medium of the audio playback device further comprises program instructions that are executable by the at least one processor of the audio playback device such that the audio playback device is configured to:
update, based on a button, a switch, or another controller belonging to the audio playback device, a pairing status indicating whether the audio playback device is in the pairing mode; and
send, to the computing device, the pairing status indicating whether the audio playback device is in the pairing mode.

13. The system of claim 11, wherein:
the pairing mode comprises a Bluetooth pairing mode or Bluetooth Low Energy (BLE) pairing mode;
to wirelessly detect the audio content comprises to detect the audio content via Bluetooth or BLE; and
to wirelessly send the audio content comprises to send the audio content via Bluetooth or BLE.

14. The system of claim 11, wherein the security credential being valid is further based on the user account being authorized to initiate the pairing mode.

15. The system of claim 11, wherein the at least one non-transitory computer-readable medium of the computing device further comprises instructions of the controller application that are executable by the at least one processor of the computing device such that the computing device is configured to display, according to a privilege level, a user interface (UI) of the controller application in a first mode or a second mode.

16. The system of claim 11, wherein the audio playback device comprises a soundbar.

17. A computing device comprising:
a communication interface;
at least one processor; and
at least one non-transitory computer-readable medium comprising instructions of a controller application, the instructions being executable by the at least one processor such that the computing device is configured to:
detect a security credential from a cloud service, wherein the security credential is associated with a user account, and the user account is associated with at least one of an audio playback device or the controller application; and
send, to the audio playback device, the security credential and a request to enter a pairing mode.

18. The computing device of claim 17, wherein the at least one non-transitory computer-readable medium further comprises instructions of the controller application that are executable by the at least one processor such that the computing device is configured to:
retrieve a pairing status from the audio playback device, wherein:
the audio playback device is configured to update the pairing status based on a button, a switch, or another controller belonging to the audio playback device; and
the pairing status indicates whether the audio playback device is in the pairing mode; and
display the pairing status via a user interface (UI) of the controller application.

19. The computing device of claim 17, wherein to send the security credential and the request to enter the pairing mode comprises to send the security credential and the request to enter the pairing mode via a local or personal area network.

20. The computing device of claim 17, wherein the at least one non-transitory computer-readable medium further comprises instructions of the controller application that are executable by the at least one processor such that the computing device is configured to display, according to a privilege level, a user interface (UI) of the controller application in a first mode or a second mode.
